(19) United States
(12) Patent Application Publication
(10) Pub. No.: US 2026/0050541 A1
(43) Pub. Date: Feb. 19, 2026

(54) Real Time Dynamic Classification and Orchestration of Test Automated Components Leveraging Supervised Learning and Multi-Modal AI

(71) Applicant: Bank of America Corporation, Charlotte, NC (US)

(72) Inventors: Michael Joseph Sukovich, Milford, PA (US); Vinod Maghnani, Gurugram (IN); Jaya Eripilla, Little Elm, TX (US)

(21) Appl. No.: 18/806,930

(22) Filed: Aug. 16, 2024

(51) Int. Cl. G06F 11/36

(52) U.S. Cl. CPC G06F 11/3698; G06F 11/3608

(57) ABSTRACT

This invention relates to systems and methods for real-time dynamic classification and orchestration of test automation components in distributed DevOps environments. The system features an Auto Identify Automation (AIA) engine that leverages supervised learning, Multi-Modal Artificial Intelligence (AI), and Generative AI technologies. It includes a Smart Scenario Designer interface that allows users to author test scenarios using handwriting and voice inputs, which are processed in real-time by AI-driven handwriting recognition, voice recognition, and Natural Language Processing (NLP). The system dynamically suggests relevant automated components via a smart bubble pane, facilitating rapid scenario creation. The architecture is tool-agnostic and scalable, with a Shared Workbench Engine that supports real-time collaboration and conflict resolution. The system continuously adapts and improves, ensuring that the automation suite remains consistent, up-to-date, and aligned with evolving software requirements, enabling efficient and user-friendly management of complex test automation processes.

### TECHNICAL FIELD

The inventions disclosed herein pertain to the field of Computing Systems and Software, particularly in the development and management of distributed computing systems where automated test components are continuously updated and managed in real-time. The application relates to the architecture and operation of software systems that support the seamless collaboration of multiple users in a DevOps environment, with a focus on enhancing the efficiency and effectiveness of software testing and deployment processes.

### DESCRIPTION OF THE RELATED ART

In modern distributed DevOps environments, continuous testing is a critical component of the software development lifecycle. The efficiency and effectiveness of this testing directly impact the quality and speed of software delivery. As projects grow and more users contribute to automation, the volume of automated test components increases exponentially. This results in a highly complex and dynamic set of test scripts, which poses significant challenges for teams, particularly those who are non-technical, such as business users, quality assurance teams, and functional testers. These challenges are exacerbated by the need for these users to leverage existing automated components while authoring new scenarios, which must be done quickly and accurately to keep pace with the demands of the development process.

One of the primary challenges in this environment is the difficulty non-technical users face in understanding and utilizing existing automated components. The scripts and test cases generated by more technical members of the team are often complex, written in various programming languages, and embedded in different tools and frameworks. Non-technical users typically do not possess the coding skills necessary to navigate these components, making it nearly impossible for them to directly interact with or modify the existing automation. This disconnect creates a bottleneck in the testing process, as these users struggle to contribute effectively to the creation of new test scenarios or the modification of existing ones.

Furthermore, as the automated components evolve, keeping track of what has been automated becomes increasingly difficult. The distributed nature of the development environment means that changes and updates to test scripts can occur at any time, often without centralized tracking or notification mechanisms. This leads to situations where users are unaware of the current state of automation, resulting in duplication of effort, where multiple users unknowingly work on automating the same scenarios. Additionally, discrepancies and redundancies in the automation code become more common, leading to inefficiencies and potential conflicts when these components are integrated.

Another significant problem is the lack of a user-friendly mechanism for authoring test scenarios in a natural, intuitive way. Current systems require users to either write code or use structured input methods, neither of which is conducive to the free-form, creative processes that many business users and testers prefer. Handwriting on a tablet or simply dictating a scenario using voice recognition are far more natural methods of input for these users. However, existing tools do not support these input methods in a way that seamlessly integrates with the automation process. This gap prevents non-technical users from easily contributing their knowledge and expertise to the creation of test scenarios, limiting the overall effectiveness of the testing process.

The complexity of managing automated components across multiple users and environments also presents a significant challenge. In a distributed DevOps setting, multiple users often work on the same project simultaneously, which can lead to conflicts and inconsistencies in the automation code. For example, two users may write similar scripts to automate the same scenario, but with slight differences that cause conflicts when the scripts are integrated. These conflicts must be manually resolved, which is time-consuming and prone to errors. Additionally, without a system to automatically detect and resolve these issues, the resulting automation suite may contain redundant or conflicting components, reducing its overall reliability and efficiency.

The continuous nature of DevOps also means that test scenarios and automation components must be constantly updated to reflect changes in the software. However, keeping the automation suite up-to-date is a daunting task, especially in environments with a high volume of automated components. Changes to the software can render existing test scripts obsolete or introduce new requirements that necessitate additional automation. Without an efficient way to identify and address these changes, the automation suite can quickly become outdated, leading to ineffective testing and potential software defects being missed.

Moreover, the dynamic nature of DevOps environments introduces the challenge of real-time collaboration among team members. As users contribute to the automation process, their changes need to be immediately reflected in the shared environment to ensure that all team members are working with the most current information. However, in practice, this level of real-time synchronization is difficult to achieve, especially when users are spread across different locations and time zones. The lack of real-time updates can lead to situations where users are working with outdated information, resulting in misaligned efforts and potential conflicts in the automation code.

Another problem is the inefficiency associated with re-inventing the wheel. In a distributed environment, it is not uncommon for different teams or users to independently develop similar automation components without knowledge of each other's work. This redundancy not only wastes time and resources but also complicates the management of the automation suite. Integrating these redundant components can lead to bloated and unwieldy codebases, making maintenance more difficult and increasing the risk of errors. Without a system to prevent this duplication of effort, organizations are unable to fully realize the benefits of automation in their DevOps processes.

The challenge of managing context is also a significant issue in test automation. As automated components evolve, their relevance and applicability to different test scenarios can change. However, existing systems do not effectively manage this context, making it difficult for users to determine whether a particular automated component is suitable for a new scenario. This lack of context management can lead to the misuse of automated components, where outdated or irrelevant scripts are applied to scenarios for which they were not designed, resulting in inaccurate or incomplete testing.

In addition to these technical challenges, there is also a cultural barrier that must be addressed. Many non-technical users are hesitant to engage with automation tools because they perceive them as being too complex or outside their area of expertise. This reluctance limits their participation in the testing process and deprives the organization of valuable insights and contributions. To overcome this barrier, there is a need for tools that are not only technically robust but also accessible and easy to use for all members of the team, regardless of their technical background.

The challenge of scaling automation efforts is another problem that organizations face. As projects grow and more users contribute to the automation suite, the system must be able to handle the increased load without compromising performance. This requires a robust and scalable architecture that can support the continuous integration and deployment of new automation components, while also ensuring that the system remains responsive and efficient. Without such a system, organizations may struggle to keep up with the demands of their DevOps processes, leading to delays and reduced effectiveness in their software development efforts.

Furthermore, the need for real-time feedback and collaboration is critical in DevOps environments. Users need immediate feedback on the impact of their changes to ensure that they are on the right track and to quickly address any issues that arise. However, existing systems often lack the ability to provide this level of real-time feedback, forcing users to wait for batch processing or manual reviews before they can see the results of their work. This delay can slow down the development process and lead to missed opportunities for optimization and improvement.

The problem of ensuring consistency across the automation suite is also a significant challenge. With multiple users contributing to the automation process, it is essential to maintain a consistent approach to how scripts are written, managed, and executed. Inconsistent practices can lead to a fragmented automation suite, where different components behave unpredictably or do not integrate well with each other. This inconsistency undermines the reliability of the automation process and can lead to defects slipping through the testing process undetected.

Finally, there is the issue of user conflicts in a multi-user environment. When multiple users are working on the same project, it is inevitable that conflicts will arise, whether due to overlapping changes, differing approaches, or miscommunications. Resolving these conflicts can be challenging, especially when they involve complex automation scripts that require technical expertise to understand and address. Without a system to automatically detect and resolve these conflicts, the process becomes more cumbersome and prone to errors.

There has been a long-felt and unmet need for a solution that addresses these challenges in a comprehensive and user-friendly manner. Existing tools and systems have failed to provide the necessary support for non-technical users, leaving them at a disadvantage in the DevOps process. Additionally, the lack of real-time collaboration, context management, and conflict resolution capabilities in current systems has hindered the effectiveness of automation efforts. The need for a system that can seamlessly integrate with existing DevOps practices, while also providing a natural and intuitive user experience, has been a significant gap in the industry. The invention meets this need by providing a solution that is accessible, efficient, and capable of addressing the unique challenges of modern DevOps environments.

### SUMMARY OF THE INVENTION

The invention disclosed herein represents a groundbreaking advancement in the realm of test automation within distributed DevOps environments. This system introduces a novel approach to the dynamic classification and orchestration of test automation components by employing a combination of supervised learning, Multi-Modal Artificial Intelligence (AI), and Generative AI technologies. These advanced technologies work in tandem to address the complexities and challenges associated with managing and optimizing large volumes of automated test scripts in a collaborative, multi-user setting. The system is meticulously designed to integrate non-technical users seamlessly into the automation process, enabling them to author and manage test scenarios through natural, intuitive input methods such as handwriting and voice dictation. This approach democratizes the automation process, allowing users from various backgrounds to contribute effectively, thereby enhancing the overall efficiency and robustness of the testing lifecycle.

At the core of the invention is the Auto Identify Automation (AIA) engine, a sophisticated system that leverages supervised learning techniques to continuously identify, classify, and update automated test components. This engine is trained to parse through a vast array of automation scripts and components, identifying relevant code while simultaneously resolving issues such as redundancies, discrepancies, duplications, and conflicts. The supervised learning component of the engine enables it to learn and adapt over time, improving its accuracy and efficiency as it processes more data. This continuous learning capability ensures that the system remains effective in dynamic environments where the automation suite is constantly evolving. By maintaining an up-to-date inventory of automated components, the AIA engine provides users with real-time access to the most current and relevant test scripts, thereby streamlining the automation process.

The Smart Scenario Designer is another pivotal feature of the invention. This user interface engine is built on top of the Multi-Modal AI engine and is designed to facilitate the creation of automation-ready test scenarios in real-time. The Smart Scenario Designer allows users to input test scenarios using natural methods such as handwriting on a tablet or voice dictation through a microphone. The Multi-Modal AI engine, equipped with handwriting recognition, voice recognition, and context sensing capabilities, processes these inputs and converts them into text. The AI engine then analyzes the text using Natural Language Processing (NLP) techniques to identify relevant automated components from a shared workbench, which serves as a centralized repository of up-to-date test scripts. This process not only simplifies the creation of test scenarios but also ensures that the scenarios are aligned with the existing automation components, reducing the risk of errors and conflicts.

The shared workbench is a central component of the invention, acting as a repository for all automated components. This workbench is continuously updated by the AIA engine, ensuring that it always contains the most current and relevant test scripts. The shared workbench plays a crucial role in facilitating collaboration among users, as it allows them to access and leverage existing automation components when creating new test scenarios. This real-time collaboration is further enhanced by the system's ability to detect and resolve conflicts that may arise when multiple users work on the same components. The Smart AI Engine, a key feature of the system, is responsible for identifying and resolving these conflicts. It uses advanced AI capabilities to detect potential issues, such as duplicated or similar code statements, and works in conjunction with the User Engine Component to resolve them. This collaborative approach ensures that the automation suite remains consistent and reliable, even as multiple users contribute to its development.

The Multi-Modal AI engine's context sensing capabilities are particularly noteworthy. This engine is designed to understand the context in which the user is authoring a test scenario, allowing it to fetch and suggest the most relevant automated components from the shared workbench. These suggestions are dynamically displayed on a smart bubble pane, which appears in real-time as the user writes or talks. The smart bubble pane is an interactive feature that allows users to easily replace their authored statements with the system's NLP-generated suggestions. This real-time interaction not only streamlines the process of creating automation-ready test scenarios but also ensures that the scenarios are optimized for the specific context in which they will be used. The system's ability to dynamically adapt to the user's input and context is a key aspect of its innovative design, providing a seamless and efficient workflow for creating and managing automated test components.

The invention also addresses the challenge of ensuring consistency across the automation suite. As multiple users contribute to the development of automated components, maintaining a consistent approach to how scripts are written, managed, and executed is essential. The Scanner Engine Component, another critical feature of the system, is responsible for scanning and identifying binding expressions within the test scripts. This component works in conjunction with the Smart AI Engine to consolidate and update the information in real-time, ensuring that all automated components are consistent with each other. This process eliminates redundancies and discrepancies within the automation suite, enhancing its overall reliability and efficiency. The system's ability to maintain consistency across the automation suite is particularly valuable in distributed environments, where users may be spread across different locations and time zones, working independently on various aspects of the automation process.

The invention's capability to handle free-form user inputs, such as handwriting and voice, is another significant aspect that enhances its usability and accessibility. The system's handwriting recognition and voice recognition components are designed to accurately capture and convert these inputs into text, which is then processed by the NLP engine. This allows users to author test scenarios in a natural and intuitive manner, without the need for specialized technical skills or coding knowledge. The system's ability to process free-form inputs also makes it highly adaptable to different user preferences and workflows, further enhancing its usability. This feature is particularly valuable in environments where non-technical users, such as business analysts and quality assurance teams, are required to contribute to the automation process. By enabling these users to input their scenarios in a manner that is most comfortable for them, the system democratizes the automation process, making it accessible to a wider range of users.

The real-time nature of the system is another critical feature that enables it to keep pace with the demands of modern DevOps environments. The system is designed to operate continuously, with all components working together to ensure that the automation suite is always up-to-date and ready for use. The Smart AI Engine Component plays a crucial role in this process by running machine learning and multi-modal AI processing in real-time. This continuous processing allows the system to detect and resolve issues as they arise, minimizing downtime and ensuring that the automation suite is always optimized for performance. The system's real-time capabilities are particularly valuable in environments where software development cycles are short, and rapid iteration is required. By providing real-time feedback and updates, the system enables users to make informed decisions quickly, thereby accelerating the development process and improving the overall quality of the software.

The system's architecture is designed to be highly scalable, making it suitable for use in large, distributed DevOps environments. The invention can handle a large volume of automated components and users without compromising on performance or efficiency. This scalability is achieved through the use of advanced AI and machine learning techniques, which enable the system to process and manage vast amounts of data in real-time. The system's ability to scale also makes it a valuable tool for organizations that need to manage complex, multi-user environments, where the volume of automated components is constantly growing. The system's scalability ensures that it can continue to deliver optimal performance, even as the demands on it increase, making it a reliable solution for organizations with diverse and evolving automation needs.

The invention's use of Generative AI technologies further enhances its ability to create highly viable test scenarios. Once the user's input is captured, whether through handwriting or voice, the system uses Generative AI to further elaborate upon and enhance the initial scenario. This process ensures that the final test scenario is not only accurate and relevant but also optimized for automation. The use of Generative AI also allows the system to adapt to changes in the software being tested, ensuring that the test scenarios remain effective even as the software evolves. This adaptability is a key feature of the invention, allowing it to remain relevant and useful in environments where software requirements and conditions are constantly changing.

The User Engine Component of the invention is designed to facilitate user-specific tracking and connect users when conflicts need to be resolved with human intervention. This component ensures that all user activities are tracked and that any potential conflicts are flagged and addressed in a timely manner. By connecting users when necessary, the system fosters collaboration and ensures that all team members are working towards a common goal. This feature is particularly valuable in distributed environments, where users may be spread across different locations and time zones. The ability to track and manage user activities in real-time ensures that the system remains efficient and that any issues are resolved quickly, minimizing the impact on the overall automation process.

The invention's ability to integrate with existing development environments is another significant advantage. The system is designed to be tool-agnostic and can work with various automation tools, programming languages, and integrated development environments (IDEs). This flexibility makes it easy to incorporate the system into existing workflows, without the need for extensive reconfiguration or retraining. The system's compatibility with different tools and environments also makes it a versatile solution for organizations with diverse automation needs. By integrating seamlessly with existing systems, the invention enhances the overall efficiency of the automation process, allowing organizations to leverage their existing tools and infrastructure while benefiting from the advanced capabilities of the AIA engine.

The invention's ability to learn and adapt over time is a key feature that enhances its effectiveness and usability. The system uses supervised learning to continuously improve its performance, learning from the data it processes and the feedback it receives from users. This adaptive learning capability ensures that the system remains effective even as the automation suite evolves and new challenges arise. The system's ability to learn from past experiences also makes it more efficient, as it can anticipate and address issues before they become problems. This continuous learning and adaptation are critical in environments where the pace of change is rapid, and the ability to quickly respond to new challenges is essential.

The invention's focus on user experience is a core aspect that sets it apart from traditional automation tools. The system is designed to be accessible and easy to use, even for non-technical users. By allowing users to author test scenarios in a natural and intuitive manner, the system empowers them to contribute more effectively to the automation process. The system's user-friendly design also reduces the learning curve, making it easier for organizations to onboard new users and integrate the system into their existing workflows. The emphasis on user experience ensures that the system is not only technically robust but also practical and accessible, making it a valuable tool for a wide range of users.

In summary, the invention disclosed herein is a comprehensive and highly advanced system for real-time dynamic classification and orchestration of test automation components. The system leverages cutting-edge technologies, including supervised learning, Multi-Modal AI, and Generative AI, to provide a user-friendly and efficient solution for managing complex automation suites in distributed DevOps environments. With its innovative features, including the Smart Scenario Designer, Shared Workbench, Multi-Modal AI Engine, and real-time collaboration capabilities, the invention addresses the unique challenges of modern DevOps and offers a powerful tool for organizations looking to optimize their automation processes. The system's scalability, adaptability, and focus on user experience make it a valuable asset for any organization seeking to enhance the efficiency and effectiveness of their test automation efforts. The invention's ability to integrate non-technical users into the automation process, while maintaining consistency, scalability, and real-time responsiveness, represents a significant advancement in the field of DevOps automation, offering a solution that is both innovative and practical in its application.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for real-time dynamic classification and orchestration of test automation components in a distributed DevOps environment includes initiating, by a user engine component, a trigger to start the process of identifying and managing automated test components within a distributed DevOps environment. The method further involves scanning, by a scanner engine component, a plurality of step definition code files and feature files to identify binding expressions, wherein the scanner engine component is tool-agnostic, script-agnostic, and language-agnostic, and is configured to focus specifically on binding expressions that link business-driven requirements with corresponding automation code. The identified binding expressions are stored, by the scanner engine component, in a first file and the corresponding matching statements from the feature files in a second file, wherein these files serve as temporary repositories for the identified automation components. Next, the method includes analyzing, by a smart AI engine component, the contents of the first and second files to detect and resolve redundancies, discrepancies, duplications, and conflicts within the automation suite, utilizing advanced artificial intelligence techniques that continuously learn and improve over time.

The method also updates, by the user engine component, user session tracking details to monitor and log user activities, wherein the user engine component is configured to detect potential conflicts in a multi-user environment and to ensure that all users are working with the most current automation components. The smart AI engine component facilitates real-time consolidation and synchronization of automation components across multiple users, ensuring that all components are consistent and up-to-date within the shared workbench. The method further includes processing, by a multi-modal AI engine component, user inputs in the form of free-form handwriting and voice, converting these inputs into text in real-time using handwriting recognition and voice recognition technologies, wherein the conversion process is optimized to handle variations in handwriting and speech patterns.

The converted text is analyzed, by a natural language processing (NLP) engine, to identify relevant automation components based on the context of the user input, and to generate contextually appropriate suggestions for inclusion in the test scenario. The multi-modal AI engine component then dynamically suggests relevant automation components via a smart bubble pane displayed on a smart scenario designer interface, wherein the smart bubble pane is continuously updated in real-time as the user writes or speaks. The user is allowed, by the smart scenario designer interface, to select and incorporate the suggested automation components into the test scenario in real-time, providing an interactive and intuitive environment for scenario creation. The method also includes storing, by a shared workbench engine component, the consolidated and updated automation components in a centralized repository, ensuring that these components are accessible to all users across the distributed environment. Furthermore, the smart AI engine component enables real-time conflict resolution among multiple users by detecting potential conflicts in the automation suite and facilitating human intervention when necessary.

The smart AI engine component also adapts to changes in the software under test by continuously learning from user inputs, feedback, and changes in the software environment, ensuring that the automation components remain relevant and effective. Additionally, the smart scenario designer interface is enabled to allow customization of the interface layout, tools, and workflows to suit individual user preferences, thereby allowing for personalized user experiences and improved productivity. The multi-modal AI engine component provides real-time feedback to users on the impact of their inputs on the test scenarios being authored, including suggestions for improvements and optimizations.

The method also includes integrating, by the system, the smart scenario designer interface with various development tools, continuous integration/continuous deployment (CI/CD) pipelines, and environments, ensuring compatibility and seamless workflow integration across the DevOps lifecycle. Finally, the method involves generating, by the generative AI component, optimized test scenarios based on the user's input, historical data, and the context of the software under test, wherein the generated scenarios are refined to maximize test coverage and efficiency, and facilitating, by the shared workbench engine component, real-time collaboration among multiple users by ensuring that all users have access to the most current and relevant automation components, supporting distributed teams working across different locations and time zones.

In some arrangements, the method of claim 1 further includes updating, by the smart AI engine component, the shared workbench engine component with newly identified and validated automated components, ensuring that the repository is continuously enriched with the latest automation scripts.

In some arrangements, the method of claim 2 further includes resolving, by the user engine component, conflicts that require human intervention by connecting relevant users through the smart scenario designer interface to collaboratively address the identified issues, thereby minimizing delays and ensuring continuity in the automation process.

In some arrangements, the method of claim 3 further includes prioritizing, by the multi-modal AI engine component, the automated components suggested in the smart bubble pane based on the specific module, feature, or priority level of the software being tested, ensuring that the most critical components are highlighted for user selection.

In some arrangements, the method of claim 4 further includes enabling, by the smart scenario designer interface, drag-and-drop functionality for reordering, restructuring, and organizing test scenarios, allowing users to easily adjust the sequence and hierarchy of test steps to optimize the testing process.

In some arrangements, the method of claim 5 further includes providing, by the multi-modal AI engine component, detailed analytics and reports to the user on the effectiveness and efficiency of the created test scenarios, including metrics on execution time, resource utilization, and defect detection rates.

In some arrangements, the method of claim 6 further includes allowing, by the smart scenario designer interface, customization of voice input settings to adapt to different accents, dialects, and speech patterns, enhancing the system's accuracy and usability for diverse user groups.

In some arrangements, the method of claim 7 further includes automatically adjusting, by the smart AI engine component, the frequency and granularity of real-time updates and suggestions based on the complexity of the test scenario, the user's preferences, and the current state of the automation suite.

In some arrangements, the method of claim 8 further includes integrating, by the system, external data sources, such as third-party APIs, databases, and cloud services, into the shared workbench engine component to enhance the relevance and accuracy of the automation component suggestions provided to users.

In some arrangements, the method of claim 9 further includes tracking, by the user engine component, the contributions and modifications made by each user to the test scenarios, providing a detailed audit trail for accountability, version control, and collaborative decision-making.

In some arrangements, the method of claim 10 further includes enabling, by the smart scenario designer interface, the export of test scenarios into multiple formats, such as XML, JSON, or script files, compatible with various automation frameworks and tools, allowing seamless integration with existing systems.

In some arrangements, the method of claim 11 further includes adapting, by the smart AI engine component, the NLP processing rules and algorithms based on historical data and user feedback, continuously improving the system's ability to interpret and generate relevant automation components.

In some arrangements, the method of claim 12 further includes allowing, by the smart scenario designer interface, the real-time simulation and preview of test scenarios to visualize potential outcomes and identify issues before the scenarios are finalized and executed, reducing the risk of defects and inefficiencies.

In some arrangements, the method of claim 13 further includes integrating, by the smart AI engine component, continuous deployment (CD) tools and services, enabling the system to automatically apply validated and approved test scenarios to the production environment as part of the CI/CD pipeline.

In some arrangements, the method of claim 14 further includes enabling, by the system, multi-language support for the smart scenario designer interface, allowing global teams to author and manage test scenarios in their preferred languages, facilitating collaboration across diverse, international teams.

In some arrangements, the method of claim 15 further includes providing, by the smart AI engine component, advanced recommendations for optimizing test scenarios, such as suggesting alternative automation components, refining test data inputs, or adjusting test execution parameters based on machine learning insights and patterns derived from past scenarios.

In some arrangements, the method of claim 16 further includes enabling, by the shared workbench engine component, version control for the automated components stored in the repository, allowing users to track changes over time, compare different versions, and revert to previous versions if necessary to maintain the integrity and reliability of the automation suite.

In some arrangements, the method of claim 17 further includes providing, by the multi-modal AI engine component, a comprehensive audit trail that logs all changes made to test scenarios, including the identity of the user who made the changes, the rationale for the modifications, and the impact on the overall automation suite, ensuring transparency and traceability throughout the automation process.

In some arrangements, a method for real-time dynamic classification and orchestration of test automation components in a distributed DevOps environment includes initiating, by a user engine component, a trigger to start the process of identifying and managing automated test components within a distributed DevOps environment. The method further involves scanning, by a scanner engine component, a plurality of step definition code files and feature files to identify binding expressions, wherein the scanner engine component is tool-agnostic, script-agnostic, and language-agnostic, and is configured to focus specifically on binding expressions that link business-driven requirements with corresponding automation code.

The identified binding expressions are stored, by the scanner engine component, in a first file and the corresponding matching statements from the feature files in a second file, wherein these files serve as temporary repositories for the identified automation components. The method includes analyzing, by a smart AI engine component, the contents of the first and second files to detect and resolve redundancies, discrepancies, duplications, and conflicts within the automation suite, utilizing advanced artificial intelligence techniques that continuously learn and improve over time. The method also updates, by the user engine component, user session tracking details to monitor and log user activities, wherein the user engine component is configured to detect potential conflicts in a multi-user environment and to ensure that all users are working with the most current automation components. The smart AI engine component facilitates real-time consolidation and synchronization of automation components across multiple users, ensuring that all components are consistent and up-to-date within the shared workbench.

The method further includes processing, by a multi-modal AI engine component, user inputs in the form of free-form handwriting and voice, converting these inputs into text in real-time using handwriting recognition and voice recognition technologies, wherein the conversion process is optimized to handle variations in handwriting and speech patterns. The converted text is analyzed, by a natural language processing (NLP) engine, to identify relevant automation components based on the context of the user input, and to generate contextually appropriate suggestions for inclusion in the test scenario. The multi-modal AI engine component then dynamically suggests relevant automation components via a smart bubble pane displayed on a smart scenario designer interface, wherein the smart bubble pane is continuously updated in real-time as the user writes or speaks.

The user is allowed, by the smart scenario designer interface, to select and incorporate the suggested automation components into the test scenario in real-time, providing an interactive and intuitive environment for scenario creation. The method also includes storing, by a shared workbench engine component, the consolidated and updated automation components in a centralized repository, ensuring that these components are accessible to all users across the distributed environment. Furthermore, the smart AI engine component enables real-time conflict resolution among multiple users by detecting potential conflicts in the automation suite and facilitating human intervention when necessary. The smart AI engine component adapts to changes in the software under test by continuously learning from user inputs, feedback, and changes in the software environment, ensuring that the automation components remain relevant and effective. The smart scenario designer interface is enabled to allow customization of the interface layout, tools, and workflows to suit individual user preferences, thereby allowing for personalized user experiences and improved productivity.

The multi-modal AI engine component provides real-time feedback to users on the impact of their inputs on the test scenarios being authored, including suggestions for improvements and optimizations. The method also includes integrating, by the system, the smart scenario designer interface with various development tools, continuous integration/continuous deployment (CI/CD) pipelines, and environments, ensuring compatibility and seamless workflow integration across the DevOps lifecycle. The method involves generating, by the generative AI component, optimized test scenarios based on the user's input, historical data, and the context of the software under test, wherein the generated scenarios are refined to maximize test scope and efficiency. Additionally, the method facilitates, by the shared workbench engine component, real-time collaboration among multiple users by ensuring that all users have access to the most current and relevant automation components, supporting distributed teams working across different locations and time zones. The method further includes updating, by the smart AI engine component, the shared workbench engine component with newly identified and validated automated components, ensuring that the repository is continuously enriched with the latest automation scripts.

The method also includes resolving, by the user engine component, conflicts that require human intervention by connecting relevant users through the smart scenario designer interface to collaboratively address the identified issues, thereby minimizing delays and ensuring continuity in the automation process. The method includes prioritizing, by the multi-modal AI engine component, the automated components suggested in the smart bubble pane based on the specific module, feature, or priority level of the software being tested, ensuring that the most critical components are highlighted for user selection.

The method further includes enabling, by the smart scenario designer interface, drag-and-drop functionality for reordering, restructuring, and organizing test scenarios, allowing users to easily adjust the sequence and hierarchy of test steps to optimize the testing process. The multi-modal AI engine component provides detailed analytics and reports to the user on the effectiveness, efficiency, and scope of the created test scenarios, including metrics on execution time, resource utilization, and defect detection rates. The method also includes allowing, by the smart scenario designer interface, customization of voice input settings to adapt to different accents, dialects, and speech patterns, enhancing the system's accuracy and usability for diverse user groups. The method further includes automatically adjusting, by the smart AI engine component, the frequency and granularity of real-time updates and suggestions based on the complexity of the test scenario, the user's preferences, and the current state of the automation suite. The method also includes integrating, by the system, external data sources, such as third-party APIs, databases, and cloud services, into the shared workbench engine component to enhance the relevance and accuracy of the automation component suggestions provided to users.

The method includes tracking, by the user engine component, the contributions and modifications made by each user to the test scenarios, providing a detailed audit trail for accountability, version control, and collaborative decision-making. The method further includes enabling, by the smart scenario designer interface, the export of test scenarios into multiple formats, such as XML, JSON, or script files, compatible with various automation frameworks and tools, allowing seamless integration with existing systems. The smart AI engine component is further adapted to continuously improve the system's ability to interpret and generate relevant automation components by refining the NLP processing rules and algorithms based on historical data and user feedback. The method also includes allowing, by the smart scenario designer interface, the real-time simulation and preview of test scenarios to visualize potential outcomes and identify issues before the scenarios are finalized and executed, reducing the risk of defects and inefficiencies.

The method includes integrating, by the smart AI engine component, continuous deployment (CD) tools and services, enabling the system to automatically apply validated and approved test scenarios to the production environment as part of the CI/CD pipeline. The system further includes enabling, by the system, multi-language support for the smart scenario designer interface, allowing global teams to author and manage test scenarios in their preferred languages, facilitating collaboration across diverse, international teams. The method also includes providing, by the smart AI engine component, advanced recommendations for optimizing test scenarios, such as suggesting alternative automation components, refining test data inputs, or adjusting test execution parameters based on machine learning insights and patterns derived from past scenarios. The method further includes enabling, by the shared workbench engine component, version control for the automated components stored in the repository, allowing users to track changes over time, compare different versions, and revert to previous versions if necessary to maintain the integrity and reliability of the automation suite.

Lastly, the method includes providing, by the multi-modal AI engine component, a comprehensive audit trail that logs all changes made to test scenarios, including the identity of the user who made the changes, the rationale for the modifications, and the impact on the overall automation suite, ensuring transparency and traceability throughout the automation process. The method also facilitates, by the smart AI engine component, automatic updates to the automation components and test scenarios based on continuous integration and deployment feedback, thereby ensuring that the automation suite evolves in alignment with the ongoing development process.

In some arrangements, a system is designed to manage and optimize automated test components in a DevOps environment, which involves collaboration across different teams and locations. The system includes several key components, each with specific functions.

First, there is a user engine component that starts the process of identifying, tracking, and managing automated test components. It monitors and logs user activities, detects potential conflicts in a multi-user environment by analyzing how users interact with the automation components, and resolves any conflicts that require human intervention by connecting the relevant users. This component also tracks the contributions and modifications made by each user to the test scenarios, providing a detailed record for accountability, version control, and collaborative decision-making.

The system also includes a scanner engine component, which scans a variety of step definition code files and feature files to identify binding expressions-specific code elements that link business requirements with automation code. This scanner is compatible with various tools, scripts, and languages, ensuring it can be used in different development environments. The scanner stores the identified binding expressions in one file and the corresponding matching statements in another file. It continues scanning and consolidating these elements until the entire automation suite is covered, ensuring comprehensive and thorough management of the automation components.

The system's smart AI engine component then analyzes the contents of these files to detect and resolve redundancies, discrepancies, duplications, and conflicts within the automation suite. This component uses advanced AI techniques, including machine learning algorithms, that continuously learn and improve based on historical data and user feedback. It facilitates real-time consolidation and synchronization of automation components across multiple users, ensuring that all components are consistent, up-to-date, and aligned with the overall testing strategy. The smart AI engine also automatically adjusts the frequency and detail level of updates, suggestions, and conflict resolutions based on the complexity of the test scenario, user preferences, and the current state of the automation suite. Additionally, it adapts to changes in the software being tested by continuously learning from user inputs, feedback, and changes in the software environment.

Another important component is the multi-modal AI engine, which processes user inputs like free-form handwriting and voice, converting these inputs into text in real-time using advanced handwriting and voice recognition technologies. This conversion is optimized to handle variations in handwriting styles, speech patterns, accents, and dialects. The system then analyzes the converted text using a natural language processing (NLP) engine to identify relevant automation components based on the specific context of the user input, such as the software module or feature being tested. The system dynamically generates contextually appropriate suggestions for automation components, continuously updating these suggestions through a smart bubble pane displayed on a smart scenario designer interface. This pane is responsive to the user's ongoing inputs and interactions.

The NLP engine itself is designed to analyze and interpret the converted text from handwriting and voice inputs, using semantic analysis, context detection, and machine learning models to accurately identify relevant automation components. It continuously adapts and refines its processing rules and algorithms based on historical data, user feedback, and evolving software requirements, ensuring that the system remains effective in interpreting and responding to user inputs over time.

The smart scenario designer interface is configured to display the smart bubble pane with relevant suggestions, allowing users to select and incorporate these components into the test scenario in real-time. The interface provides an interactive, user-friendly environment for scenario creation, enabling users to easily input, modify, and organize test scenarios using drag-and-drop functionality and other intuitive tools. Users can customize the interface layout, tools, and workflows to suit their individual preferences, enhancing productivity and user satisfaction. The interface also supports voice input customization, adapting to different accents, speech patterns, and languages to ensure accuracy and inclusivity for a diverse range of users. Additionally, the interface allows for real-time simulation and preview of test scenarios, enabling users to visualize potential outcomes, identify issues, and make adjustments before finalizing and executing the scenarios, thus reducing the risk of defects and inefficiencies. Furthermore, the interface supports the export of test scenarios into multiple formats, such as XML, JSON, or script files, ensuring compatibility with various automation frameworks, tools, and CI/CD pipelines.

The shared workbench engine component is another critical part of the system. It stores the consolidated and updated automation components in a centralized repository accessible to all users across the distributed environment, ensuring these components are always current and relevant. This component facilitates real-time collaboration among multiple users, ensuring that all team members have access to the most up-to-date automation components. It also integrates external data sources, including third-party APIs, databases, and cloud services, into the shared workbench to enhance the relevance, accuracy, and scope of the automation component suggestions provided to users. Additionally, it enables version control for the automated components stored in the repository, allowing users to track changes over time, compare different versions, and revert to previous versions if necessary to maintain the integrity and reliability of the automation suite.

The system also includes a generative AI component that generates optimized test scenarios based on the user's input, historical data, and the context of the software under test. The generated scenarios are refined to maximize test scope, efficiency, and alignment with the overall testing strategy. This component provides advanced recommendations for optimizing test scenarios, such as suggesting alternative automation components, refining test data inputs, or adjusting test execution parameters based on machine learning insights derived from past scenarios. It continuously updates and refines the generated test scenarios based on ongoing feedback from the CI/CD process, ensuring that the scenarios remain relevant and effective as the software evolves.

For continuous deployment (CD), the system includes a CD integration module that automatically applies validated and approved test scenarios to the production environment as part of the CI/CD pipeline, ensuring seamless integration of the automated tests into the overall software deployment process. This module adapts the deployment process based on real-time feedback and changes in the software under test, ensuring that the automation suite remains aligned with the latest software updates and releases.

Additionally, the system has a multi-language support module that enables the smart scenario designer interface to support multiple languages, allowing global teams to author, manage, and collaborate on test scenarios in their preferred languages. This module provides language-specific optimizations for handwriting and voice recognition, ensuring accuracy and usability across different linguistic contexts.

Finally, the system includes an audit trail module that provides a comprehensive log of all changes made to test scenarios, including the identity of the user who made the changes, the rationale for the modifications, and the impact on the overall automation suite. This ensures transparency, accountability, and traceability throughout the automation process. Users can access and review the audit trail at any time, supporting compliance, quality assurance, and collaborative decision-making within the DevOps environment. Additionally, the system is configured to automatically update automation components and test scenarios based on continuous integration and deployment feedback, ensuring that the automation suite evolves in alignment with ongoing development processes. The system also facilitates real-time monitoring and analysis of test scenario execution, providing insights and metrics that enable users to continuously optimize their automation strategies and improve software quality over time.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 provides an overview of the distributed automation workbench architecture, highlighting the interaction between various components within the DevOps environment. The figure emphasizes how these components work together to support real-time collaboration and automated test management.

FIG. 2 illustrates the detailed operational flow of the Auto Identify Automation (AIA) engine, showing the sequential steps involved in scanning, identifying, and consolidating automation components. The figure demonstrates how the system ensures that all test components are up-to-date and aligned with business-driven requirements.

FIG. 3 presents the Smart Scenario Designer interface, depicting how users can create and manage automated test scenarios using a combination of handwriting, voice inputs, and real-time AI-driven suggestions. The figure highlights the dynamic interaction between the user and the system, facilitating efficient scenario creation and modification.

FIGS. 4A-4D depict a detailed sequence diagram illustrating the process flow for real-time dynamic classification and orchestration of test automation components in a distributed DevOps environment. The diagrams show the interaction between various system components, from initiating the process and scanning code files to analyzing, updating, and synchronizing automation components across multiple users and environments.

FIG. 5 depicts a class diagram illustrating the detailed architecture of the system for real-time dynamic classification and orchestration of test automation components in a distributed DevOps environment. The diagram showcases the various components, their attributes, methods, and interactions necessary to manage and optimize the automation suite effectively.

### DETAILED DESCRIPTION

The inventions presented are sophisticated systems and methods designed to revolutionize the way test automation components are managed and orchestrated within distributed DevOps environments. At its core, the invention(s) introduce an Auto Identify Automation (AIA) engine that leverages advanced technologies such as supervised learning and Multi-Modal Artificial Intelligence (AI). This engine is integral to the system's ability to dynamically classify, organize, and maintain automated test components in real-time. By utilizing these advanced techniques, the system ensures that the complex and ever-evolving landscape of automated test scripts is efficiently managed, reducing redundancy and optimizing the overall workflow.

One of the key aspects of the invention is its ability to seamlessly integrate non-technical users into the test automation process. Traditionally, test automation has been a domain reserved for those with technical expertise, particularly in programming and scripting. However, this invention democratizes the process by allowing users to contribute through natural and intuitive methods such as handwriting and voice input. The system is equipped with advanced handwriting recognition and voice recognition capabilities, which are processed by a powerful Multi-Modal AI engine. This engine converts these inputs into actionable text, which can then be analyzed and integrated into the test automation workflow.

The Smart Scenario Designer is another essential component of the system. This user interface engine allows users to create pre-automated test scenarios in real-time, leveraging the Multi-Modal AI engine's capabilities. The Smart Scenario Designer is designed to be user-friendly, enabling non-technical users to author test scenarios using methods that are comfortable and familiar to them. Whether through handwriting on a tablet or speaking into a microphone, users can input their scenarios naturally, and the system will process these inputs, identify relevant automated components, and provide real-time feedback and suggestions.

The system's use of supervised learning is a standout feature, allowing it to continuously improve its ability to identify and manage automated test components. The AIA engine is trained to parse through a wide array of automation scripts, recognizing relevant components while resolving issues such as redundancies, discrepancies, and conflicts. This continuous learning capability ensures that the system remains up-to-date with the latest developments in the automation suite, providing users with the most relevant and efficient test scripts available. This aspect of the invention is crucial for maintaining the system's effectiveness in fast-paced and dynamic DevOps environments.

Collaboration is a fundamental aspect of the invention, facilitated by the Shared Workbench Engine Component. This component acts as a central repository for all automated components, ensuring that all team members have access to the most current and relevant test scripts. The shared workbench also supports real-time collaboration, allowing multiple users to contribute to the automation process simultaneously. The system is designed to detect and resolve conflicts that may arise when users work on the same components, ensuring that the automation suite remains consistent and reliable.

The invention also includes a sophisticated conflict resolution mechanism, which is managed by the Smart AI Engine Component. This engine uses advanced AI capabilities to identify and resolve potential conflicts, such as duplicated or similar code statements, that may occur in a multi-user environment. The system's ability to automatically detect and address these conflicts in real-time is a key feature that enhances its reliability and efficiency. By minimizing the need for manual conflict resolution, the system streamlines the automation process and reduces the risk of errors.

Context sensing is another innovative feature of the system, provided by the Multi-Modal AI engine. This engine is designed to understand the context in which the user is authoring a test scenario, allowing it to fetch and suggest the most relevant automated components from the shared workbench. These suggestions are dynamically presented to the user in real-time, enabling them to quickly and easily incorporate the suggested components into their scenarios. This real-time context awareness significantly improves the accuracy and relevance of the test scenarios generated by the system.

Scalability is a critical feature of the invention, making it suitable for use in large, distributed DevOps environments. The system is capable of handling a high volume of automated components and users without compromising performance or efficiency. This scalability is achieved through the use of advanced AI and machine learning techniques, which allow the system to process and manage vast amounts of data in real-time. The system's ability to scale ensures that it can meet the demands of growing organizations and complex projects, making it a reliable solution for managing test automation in any setting.

Another key aspect of the invention is its adaptability, particularly in how it handles changes in the software being tested. The system is designed to remain effective even as the software evolves, using Generative AI technologies to adapt test scenarios to new conditions and requirements. This adaptability ensures that the test scenarios generated by the system remain relevant and accurate, even as the software under test changes. This feature is particularly valuable in environments where software development cycles are rapid and continuous integration is required.

The invention also emphasizes user experience, making the system accessible and easy to use for all members of the team, regardless of their technical background. By providing a user-friendly interface and natural input methods, the system empowers non-technical users to contribute to the test automation process effectively. This focus on usability ensures that the system can be adopted quickly and easily by organizations, reducing the learning curve and enhancing overall productivity.

Real-time feedback is another crucial feature of the system, enabling users to see the results of their inputs and changes immediately. This feature is particularly valuable in fast-paced DevOps environments, where rapid iteration and immediate feedback are essential. By providing real-time feedback, the system allows users to make informed decisions quickly, reducing the time required to develop and refine test scenarios.

The system's architecture is designed to be tool-agnostic, meaning it can integrate seamlessly with a wide range of existing development tools and environments. This flexibility makes it easy to incorporate the system into existing workflows without the need for extensive reconfiguration or retraining. The system's compatibility with various tools and environments also enhances its versatility, making it a valuable solution for organizations with diverse automation needs.

The system's continuous learning capability, driven by supervised learning, ensures that it remains effective over time. As the system processes more data and receives feedback from users, it becomes increasingly accurate and efficient. This ability to learn and adapt is critical in environments where the pace of change is rapid, allowing the system to keep up with new developments and challenges as they arise.

The invention also includes features that facilitate user-specific tracking and collaboration. The User Engine Component tracks all user activities, ensuring that potential conflicts are flagged and addressed promptly. By connecting users when necessary, the system fosters collaboration and ensures that all team members are aligned and working towards common goals. This feature is particularly valuable in distributed environments, where users may be spread across different locations and time zones.

In summary, the invention is a comprehensive and advanced system designed to enhance the efficiency and effectiveness of test automation in distributed DevOps environments. By leveraging cutting-edge technologies such as supervised learning, Multi-Modal AI, and Generative AI, the system provides a user-friendly and scalable solution for managing complex automation suites. The system's innovative features, including the Smart Scenario Designer, Shared Workbench, and real-time conflict resolution capabilities, make it a powerful tool for organizations looking to optimize their automation processes. The invention's focus on usability, adaptability, and real-time feedback ensures that it can meet the needs of any organization, making it a valuable asset in the ever-evolving world of software development and testing.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

Terms such as “computers,” “machines,” and similar phrases are used interchangeably based on the context to denote devices that may be general-purpose or specialized for specific functions, whether virtual or physical, and capable of network connectivity. This encompasses all pertinent hardware, software, and components known to those skilled in the field. Such devices might feature specialized circuits like application-specific integrated circuits (ASICs), microprocessors, cores, or other processing units for executing, accessing, controlling, or implementing various types of software, instructions, data, modules, processes, or routines. The employment of these terms within this document is not intended to restrict or exclusively refer to any specific type of electronic devices or components, and should be interpreted broadly by those with relevant expertise. For conciseness and assuming familiarity, detailed descriptions of computer/software components and machines are omitted.

Software, executable code, data, modules, procedures, and similar entities may reside on tangible, physical computer-readable storage devices. This includes a range from local memory to network-attached storage, and various other accessible memory types, whether removable, remote, cloud-based, or accessible through other means. These elements can be stored in both volatile and non-volatile memory forms and may operate under different conditions such as autonomously, on-demand, as per a preset schedule, spontaneously, proactively, or in response to certain triggers. They may be consolidated or distributed across multiple computers or devices, integrating their memory and other components. These elements can also be located or dispersed across network-accessible storage systems, within distributed databases, big data infrastructures, blockchains, or distributed ledger technologies, whether collectively or in distributed configurations.

The term “networks” and similar references encompass a wide array of communication systems, including local area networks (LANs), wide area networks (WANs), the Internet, cloud-based networks, and both wired and wireless configurations. This category also covers specialized networks such as digital subscriber line (DSL) networks, frame relay networks, asynchronous transfer mode (ATM) networks, and virtual private networks (VPN), which may be interconnected in various configurations. Networks are equipped with specific interfaces to facilitate diverse types of communications—internal, external, and administrative—and have the ability to assign virtual IP addresses (VIPs) as needed. Network architecture involves a suite of hardware and software components, including but not limited to access points, network adapters, buses, both wired and wireless ethernet adapters, firewalls, hubs, modems, routers, and switches, which may be situated within the network, on its edge, or externally. Software and executable instructions operate on these components to facilitate network functions. Moreover, networks support HTTPS and numerous other communication protocols, enabling them to handle packet-based data transmission and communications effectively.

As used herein, Generative Artificial Intelligence (AI) or the like refers to AI techniques that learn from a representation of training data and use it to generate new content similar to or inspired by existing data. Generated content may include human-like outputs such as natural language text, source code, images/videos, and audio samples. Generative AI solutions typically leverage open-source or vendor sourced (proprietary) models, and can be provisioned in many ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used under various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models-Meta LLAMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in biology and medicine. (5) NVIDIA AI Models-Megatron: A large, powerful transformer model designed for natural language processing tasks. (6) IBM AI Models-Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in generative AI. One or more of the foregoing may be used herein as desired. All are considered within the sphere and scope of this disclosure.

Generative AI and LLMs can be used in various parts of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and using large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

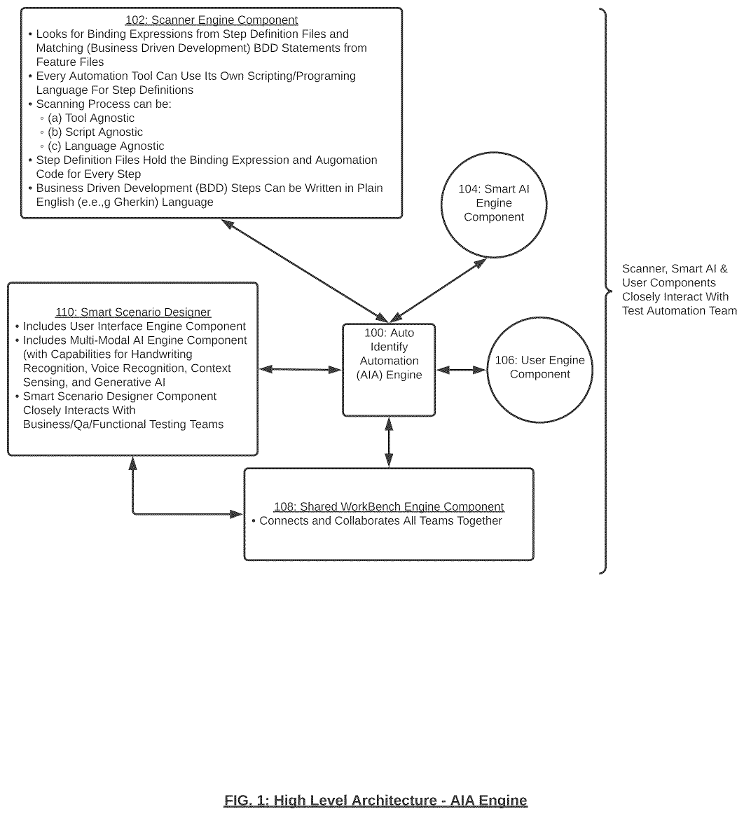

FIG. 1 provides a comprehensive and intricate depiction of the high-level architecture of the Auto Identify Automation (AIA) engine, which is the central component of the invention. The AIA engine, designated by the numeral 100 in the figure, serves as the core mechanism for autonomously identifying, classifying, and orchestrating test automation components within a distributed DevOps environment. The architecture depicted in FIG. 1 illustrates the interconnectedness and collaborative functions of several key components that work in harmony to optimize the automation process.

At the heart of the AIA engine's functionality is the Scanner Engine Component, represented by the numeral 102. This component is engineered to meticulously scan step definition files to identify binding expressions, which are crucial for linking high-level business requirements—often written in plain English or languages like Gherkin in BDD—with the corresponding automation code. The scanning process performed by the Scanner Engine Component is tool-agnostic, script-agnostic, and language-agnostic, ensuring that it can operate effectively across various programming languages and development environments. This versatility is critical in a distributed environment where different teams might use different tools and languages, yet the Scanner Engine Component 102 ensures a seamless identification process, capturing the automation components necessary for the next stages of processing.

Closely integrated with the Scanner Engine Component is the Smart AI Engine Component, denoted by the numeral 104. The Smart AI Engine 104 plays a pivotal role in the system by utilizing advanced artificial intelligence techniques to manage the complexities inherent in test automation. One of its primary functions is to identify and resolve redundancies, discrepancies, duplications, and conflicts within the automation suite. As the Scanner Engine Component 102 feeds identified automation components into the system, the Smart AI Engine 104 analyzes these components to ensure that they are optimized and free from issues that could compromise the integrity of the automated test suite. This engine is continuously learning and adapting, which enables it to refine its processes and improve the accuracy and efficiency of conflict resolution over time.

The User Engine Component, marked as numeral 106 in the figure, is another critical element within the AIA engine's architecture. This component is tasked with tracking user activities and managing user-specific session data, which is essential in a multi-user environment. In such settings, multiple users might be working simultaneously on different aspects of the automation suite, leading to potential conflicts or overlapping efforts. The User Engine Component 106 ensures that all user actions are monitored and recorded, allowing the system to detect and flag any conflicts that may arise. When conflicts are detected that cannot be resolved automatically by the Smart AI Engine 104, the User Engine Component 106 steps in to facilitate human intervention, connecting the relevant users to collaboratively resolve the issue. This mechanism ensures that the automation process remains smooth and that all users are aligned and working with the most up-to-date information.

Another integral part of the AIA engine's architecture is the Smart Scenario Designer, identified as numeral 110 in the figure. The Smart Scenario Designer is designed to empower users to create automation-ready test scenarios in real-time, using a user interface that is intuitive and accessible, even for non-technical users. The Smart Scenario Designer includes a User Interface Engine Component and a Multi-Modal AI Engine Component, both of which are instrumental in processing user inputs. Users can author test scenarios using natural methods such as handwriting on a tablet or dictating their scenarios using voice commands. The Multi-Modal AI Engine Component is equipped with handwriting recognition, voice recognition, and context sensing capabilities, allowing it to accurately capture, interpret, and convert these inputs into actionable automation scripts. This process democratizes the automation creation process, enabling a broader range of users to contribute effectively, regardless of their technical expertise.

The Shared Workbench Engine Component, denoted by numeral 108, is crucial for maintaining a centralized repository of all automated components. This component connects and collaborates across various teams, ensuring that everyone has access to the most current and relevant automation scripts. The Shared Workbench Engine Component 108 facilitates real-time collaboration, enabling users to contribute to the automation process simultaneously without fear of duplicating efforts or working with outdated information. By centralizing the automation components, this component ensures that all users are working from a single source of truth, enhancing the efficiency and reliability of the overall automation process.

The architecture depicted in FIG. 1 highlights the dynamic interactions between these components, which are designed to operate in concert to manage the complexities of test automation in a distributed DevOps environment. The Scanner Engine Component 102 identifies and categorizes automation components, which are then processed by the Smart AI Engine 104 to resolve any conflicts or redundancies. The User Engine Component 106 tracks user activities and facilitates the resolution of any issues requiring human intervention, while the Smart Scenario Designer 110 empowers users to create new automation-ready scenarios in real-time. The Shared Workbench Engine Component 108 ensures that all teams have access to the most up-to-date automation components, supporting real-time collaboration and reducing the risk of errors.

The architecture of the AIA engine is designed to be both flexible and robust, capable of adapting to a wide range of development environments and workflows. Its tool-agnostic, script-agnostic, and language-agnostic design ensures that it can be integrated into any existing DevOps process, regardless of the specific tools or languages in use. This adaptability is critical in modern development environments, where teams often use a diverse array of tools and technologies. By providing a centralized, intelligent system for managing test automation components, the AIA engine simplifies the process of maintaining a comprehensive and up-to-date automation suite.

The continuous learning capabilities of the Smart AI Engine Component 104 are particularly noteworthy, as they allow the system to refine its processes and improve its effectiveness over time. As the system processes more data and receives feedback from users, it becomes increasingly adept at identifying and resolving conflicts, optimizing the automation suite, and ensuring that all components are aligned with the latest requirements. This continuous improvement is essential in environments where the pace of development is rapid and the demands on the automation suite are constantly evolving.

The ability of the Smart Scenario Designer 110 to handle free-form user inputs such as handwriting and voice is another significant innovation. This capability makes the system accessible to a wider range of users, including those who may not have the technical expertise to write code but who nonetheless have valuable insights to contribute to the automation process. By allowing these users to input their scenarios in a natural and intuitive manner, the system broadens the pool of contributors to the automation process, enhancing the overall quality and scope of the test suite.

In summary, FIG. 1 provides a detailed and integrated view of the AIA engine's architecture, showcasing the complex interplay between its various components. The architecture is designed to be adaptable, user-friendly, and capable of handling the challenges of test automation in a modern, distributed DevOps environment. By providing a comprehensive framework for identifying, categorizing, and managing automated test components, the AIA engine enhances the efficiency, reliability, and scalability of the test automation process, making it an invaluable tool for organizations seeking to optimize their DevOps workflows.

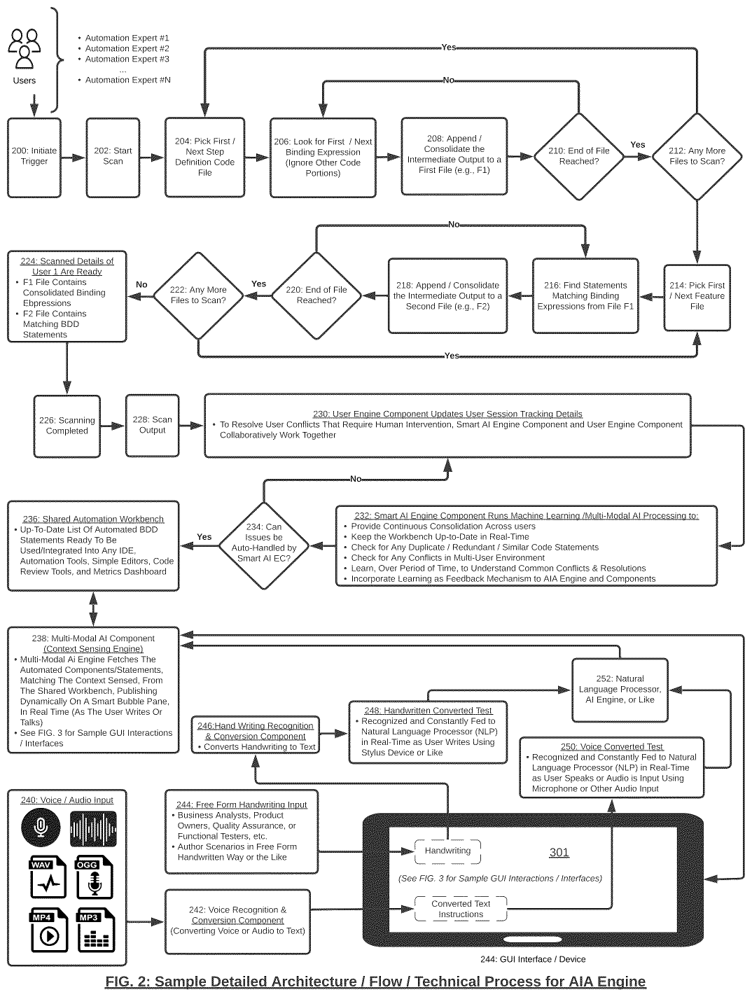

FIG. 2 provides a comprehensive and intricate representation of the detailed architecture and operational flow of the Auto Identify Automation (AIA) engine, a critical component of the invention designed to manage and optimize automated test components in real-time within a distributed DevOps environment. The figure meticulously outlines each step of the process, showcasing how the AIA engine systematically scans, identifies, and consolidates automation components while ensuring that they are up-to-date and aligned with the overall testing strategy. The process begins with the user-initiated trigger, represented by numeral 200, which sets the entire operation in motion. This trigger is crucial as it activates the AIA engine's scanning process, signaling the system to start analyzing the automation suite for relevant components.

Once the trigger is activated, the system moves to the Start Scan phase, denoted by numeral 202. During this phase, the Scanner Engine Component begins its critical task of scanning through the relevant files within the automation suite. This component is specifically designed to handle a wide variety of files, including step definition files and feature files, ensuring that all necessary elements are thoroughly analyzed. The system then proceeds to pick the first or next step definition code file, as indicated by numeral 204. These files contain binding expressions, which are essential for linking high-level business requirements—often articulated in plain English in methodologies like Business Driven Development (BDD)—with the corresponding automation code. The selection of these files is strategic, focusing on those that are most likely to contain the crucial binding expressions needed for the subsequent stages of the process.

The next phase, represented by numeral 206, involves the Scanner Engine Component meticulously searching for the first or next binding expression within the selected step definition code file. The system is engineered to efficiently identify these binding expressions while deliberately ignoring other portions of the code that are not relevant to the automation process. This targeted scanning approach is highly effective in extracting the essential elements needed to map business requirements to automated test scenarios, ensuring that the process is both accurate and efficient. Once the relevant binding expressions are identified, the system consolidates this intermediate output into a first file, referred to as F1, as shown by numeral 208. F1 serves as a temporary repository that organizes the binding expressions, preparing them for the next phase of processing.

After consolidating the binding expressions into F1, the system checks whether the end of the file has been reached, as indicated by numeral 210. This step is crucial for determining whether the current file has been fully analyzed or if additional scanning is required. If the end of the file has not been reached, the system continues to scan the remaining portions of the file for additional binding expressions. However, if the end of the file is indeed reached, the system proceeds to the next step in the process. The system then checks whether there are any more files to scan, as depicted by numeral 212. If additional files are available, the process repeats, with the system picking the next feature file, as indicated by numeral 214.

In the subsequent phase, the system focuses on identifying statements within the newly selected feature file that match the binding expressions previously consolidated in F1, as illustrated by numeral 216. This matching process is critical for ensuring that the test scenarios are correctly aligned with the existing automation components. By cross-referencing the feature files with the binding expressions, the system ensures that all relevant elements are captured and properly linked, providing a solid foundation for the automation process.

Once the matching statements are identified, the system consolidates this information into a second file, referred to as F2, as shown by numeral 218. F2 serves as a comprehensive repository that includes both the binding expressions and the matching statements, ensuring that all necessary components are organized and ready for further processing. The system then checks whether the end of the feature file has been reached, as indicated by numeral 220. If the end of the file has not been reached, the system continues to scan for additional matching statements. If the end of the file is reached, the system moves on to determine if there are any more files to scan, as depicted by numeral 222.

The naming conventions of F1 and F2 are merely generic illustrations for demonstration purposes. Any names may be used and may change as necessary and/or be incremented to account for as many files as required.

If additional files remain, the system repeats the process of scanning and identifying binding expressions and matching statements. This iterative process ensures that every relevant file is thoroughly analyzed and that all essential components are captured. Once all files have been scanned and the necessary information consolidated, the system prepares the scanned details of the first user, as indicated by numeral 224. This preparation step involves organizing the binding expressions in F1 and the matching BDD statements in F2, ensuring that they are ready for the next phase of processing.

The scanning process culminates with the completion of the scan, as represented by numeral 226. At this point, the system generates the scan output, depicted by numeral 228, which contains the consolidated and optimized automation components. These components are now ready for further analysis and refinement by the Smart AI Engine Component. The User Engine Component, represented by numeral 230, plays a crucial role at this stage by updating the user session tracking details. This component ensures that all user activities are recorded, providing a comprehensive log of actions that is essential for detecting and resolving potential conflicts.

The Smart AI Engine Component, denoted by numeral 232, then takes over to perform a series of advanced AI-driven processing tasks. These tasks include continuous consolidation of automation components across all users, keeping the workbench up-to-date in real-time, and checking for duplicate or redundant code statements. Additionally, the Smart AI Engine Component is responsible for identifying and resolving any conflicts that may arise in a multi-user environment. This component's ability to learn over time allows it to understand common conflicts and resolutions, incorporating this knowledge as feedback to continuously improve the AIA engine's overall performance.

If the Smart AI Engine Component determines that an issue cannot be automatically handled, as indicated by numeral 234, the system escalates the issue for human intervention. This escalation process is critical for ensuring that complex or ambiguous issues are resolved accurately, preserving the integrity of the automation suite. If the issue can be handled automatically, the system proceeds to update the Shared Automation Workbench, depicted by numeral 236. This workbench is a central repository that contains an up-to-date list of automated BDD statements, which are ready to be used or integrated into various development environments, including IDEs, automation tools, simple editors, code review tools, and metrics dashboards.

The Multi-Modal AI Component, represented by numeral 238, plays a pivotal role in the system by processing context-sensitive inputs from users. This component is responsible for fetching automated components or statements that match the context sensed from the shared workbench and dynamically publishing them on a smart bubble pane in real-time. The Multi-Modal AI Component processes various forms of input, including voice and handwriting, ensuring that all user inputs are accurately recognized and converted into text. This capability is particularly valuable for non-technical users, as it allows them to interact with the system using natural and intuitive methods.

The system processes voice input, depicted by numeral 240, through the Voice Recognition and Conversion Component, indicated by numeral 242. This component converts voice or audio inputs into text, which is then processed by the Natural Language Processor (NLP) to generate automation-ready statements. The system's ability to accurately convert spoken input into actionable automation components is a significant innovation, enabling users to contribute to the automation process without needing to write code.

Similarly, free-form handwriting input, depicted by numeral 244, is processed by the Handwriting Recognition and Conversion Component, represented by numeral 246. This component converts handwritten inputs into text, which is then fed into the NLP in real-time. The converted text from handwriting input is shown by numeral 248, and the converted text from voice input is depicted by numeral 250. Both forms of converted text are constantly fed into the NLP in real-time, ensuring that the automation process is dynamic and responsive to user inputs. The NLP, represented by numeral 252, is a critical component of the system, responsible for processing and interpreting user inputs to generate automation-ready test scenarios.

In summary, FIG. 2 offers a detailed and expansive view of the AIA engine's architecture, showcasing the meticulous processes and interactions involved in managing and optimizing automated test components. The figure highlights the system's ability to handle complex tasks such as scanning, identifying, and consolidating automation components, while also providing advanced AI-driven capabilities for conflict resolution, context-sensitive input processing, and real-time collaboration. The intricate processes depicted in FIG. 2 demonstrate the system's capability to manage the challenges of test automation in a distributed DevOps environment, ensuring that the automation suite remains consistent, up-to-date, and aligned with the overall testing strategy. Through its advanced AI and multi-modal input processing capabilities, the system provides a robust, scalable, and user-friendly solution for managing test automation in modern software development environments.

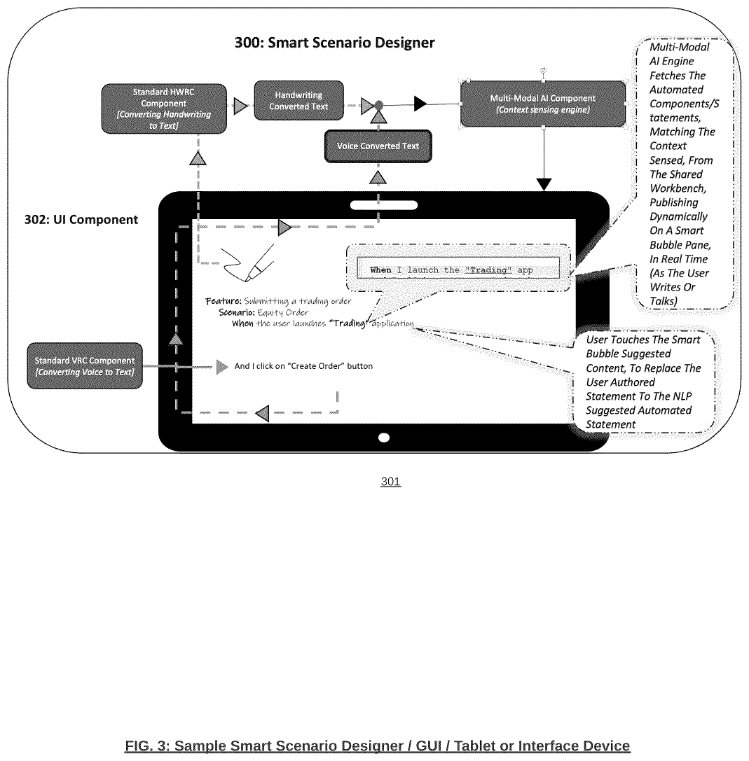

FIG. 3 presents an extensive depiction of the Smart Scenario Designer interface, which plays a crucial role in enabling users to interact with the Auto Identify Automation (AIA) engine, central to the invention. This interface is a sophisticated, user-centric environment that allows for the seamless creation, modification, and management of automated test scenarios, leveraging the full capabilities of the AIA engine. The interface is designed with a focus on usability, making it accessible to a wide range of users, including those who may not have technical expertise in coding or test automation. By providing an intuitive and interactive platform, the Smart Scenario Designer facilitates the real-time generation of automation-ready test scenarios, significantly enhancing the efficiency and effectiveness of the test automation process.

At the core of the interface, identified by numeral 301, is its ability to process and integrate various forms of user input, including free-form handwriting and voice. The interface allows users to write test scenarios by hand using a stylus on a tablet or similar touch-sensitive device. The handwriting recognition component of the Multi-Modal AI engine within the AIA system processes these handwritten inputs, converting them into text in real-time. This conversion is crucial as it allows the system to understand and integrate these natural forms of input into the automated test scenarios. The text generated from handwriting is immediately analyzed by the system's Natural Language Processing (NLP) engine, which identifies relevant automation components and generates suggestions that are displayed on the interface's smart bubble pane.

The smart bubble pane is one of the standout features of the Smart Scenario Designer interface. It is a dynamic and interactive element that continuously updates as the user writes or speaks, offering contextually relevant suggestions and automated components fetched from the shared workbench. This pane is highly responsive to the user's input, providing immediate feedback and options that the user can easily incorporate into their scenarios. For instance, as a user begins to draft a test scenario, the smart bubble pane might suggest pre-existing automated steps or components that match the context of what is being authored. The user can then select these suggestions with a simple touch or click, seamlessly integrating them into the scenario they are developing. This process not only saves time but also ensures that the scenarios being created are consistent with existing automation frameworks, reducing the risk of errors or redundant efforts.

Voice input is another critical feature supported by the Smart Scenario Designer. Users can dictate their test scenarios using a standard microphone, and the system's voice recognition component captures and converts this speech into text in real-time. Similar to handwriting input, the converted text is processed by the NLP engine, which analyzes the content to determine its relevance to existing automation components. The system then provides contextually appropriate suggestions via the smart bubble pane, just as it does with handwritten inputs. This capability allows users to interact with the system in a way that feels natural and intuitive, without the need to engage in complex coding or scripting. By accommodating both voice and handwriting inputs, the Smart Scenario Designer broadens the range of users who can contribute to the automation process, making it more inclusive and versatile.

The interface is designed to be highly adaptable, with a layout that can be customized according to the user's preferences and needs. This adaptability ensures that the interface can meet the diverse requirements of different users, from non-technical business analysts to seasoned automation engineers. The tools and controls within the interface are organized in a manner that prioritizes ease of use, with all essential functions readily accessible. This thoughtful design reduces the learning curve for new users, allowing them to become proficient with the system more quickly and contribute effectively to the automation process. Furthermore, the interface's customizable nature ensures that it can be integrated into various workflows, accommodating the unique processes of different organizations.

A significant aspect of the Smart Scenario Designer interface is its context-aware capabilities, powered by the Multi-Modal AI engine. The system is designed to understand the broader context of the user's input, enabling it to provide suggestions that are not only relevant but also highly specific to the task at hand. For example, if a user is authoring a scenario related to a particular module or feature of the software under test, the system can prioritize and suggest automation components that are directly applicable to that module. This context sensitivity ensures that the automation components being integrated into the test scenarios are the most appropriate and effective, enhancing the overall quality and accuracy of the testing process.

The interface also supports real-time collaboration among multiple users, a feature that is particularly valuable in distributed DevOps environments. Through its integration with the Shared Workbench Engine, the interface ensures that all users have access to the most current and relevant automation components, regardless of their location. This real-time collaboration capability minimizes the risk of conflicting or redundant efforts, as all team members can see and use the same up-to-date resources. The interface's collaborative features are designed to foster a unified approach to test automation, aligning all users with the same objectives and ensuring consistency across the entire automation suite.

The Smart Scenario Designer also includes advanced features for managing and organizing test scenarios. Users can easily modify, edit, and organize their scenarios within the interface, with tools designed to streamline these tasks. For instance, the interface may include drag-and-drop functionality, allowing users to reorder or restructure test scenarios with minimal effort. This ease of management is crucial for maintaining a well-organized and efficient automation suite, especially as the number of scenarios grows over time. The interface's organizational tools help users maintain clarity and control over their work, reducing the likelihood of errors and improving the overall efficiency of the automation process.

Real-time feedback is another cornerstone of the Smart Scenario Designer interface. As users input their scenarios, whether by writing or speaking, the system processes this input instantly, providing immediate feedback through the smart bubble pane. This feedback loop is essential for ensuring that users can see the results of their input and make adjustments on the fly. It also encourages experimentation, as users can quickly test different approaches and see how the system responds. This instant feedback not only accelerates the scenario creation process but also enhances the overall user experience, making the interface both efficient and engaging.

The interface is also designed with an emphasis on scalability and flexibility. It can handle a large volume of test scenarios and users without compromising performance, making it suitable for use in large, complex projects. The system's scalability is supported by its underlying AI and machine learning technologies, which allow it to process and manage vast amounts of data in real-time. This scalability ensures that the Smart Scenario Designer can grow with the needs of the organization, remaining a valuable tool even as projects expand and evolve.

The interface's integration with Generative AI technologies further enhances its capabilities. Once user input is captured and processed, the system can use Generative AI to elaborate upon and refine the initial test scenarios, making them more robust and automation-ready. This capability ensures that the scenarios produced are not only accurate but also optimized for the specific requirements of the testing process. The Generative AI can adapt the scenarios to changing conditions, ensuring that they remain relevant even as the software under test evolves. This adaptability is a key strength of the Smart Scenario Designer, enabling it to keep pace with the dynamic nature of software development.

Finally, the Smart Scenario Designer interface is designed to be future-proof, with features that allow it to adapt to new technologies and methodologies as they emerge. The system is built with a flexible architecture that can incorporate new tools, inputs, and processes, ensuring that it remains relevant and effective in the long term. This forward-looking design is essential for organizations that need to stay at the cutting edge of test automation, providing them with a tool that can evolve alongside their needs.

Overall, FIG. 3 provides an expansive and detailed view of the Smart Scenario Designer interface, highlighting its many features and capabilities. The interface is designed to be intuitive, flexible, and highly interactive, making it an essential tool for managing test automation in modern DevOps environments. Through its integration with the AIA engine and its support for various input methods, the Smart Scenario Designer empowers users to create and manage automated test scenarios with unprecedented ease and efficiency. Its context-aware, collaborative, and scalable design ensures that it can meet the diverse needs of different users and organizations, making it a valuable asset in the field of test automation.

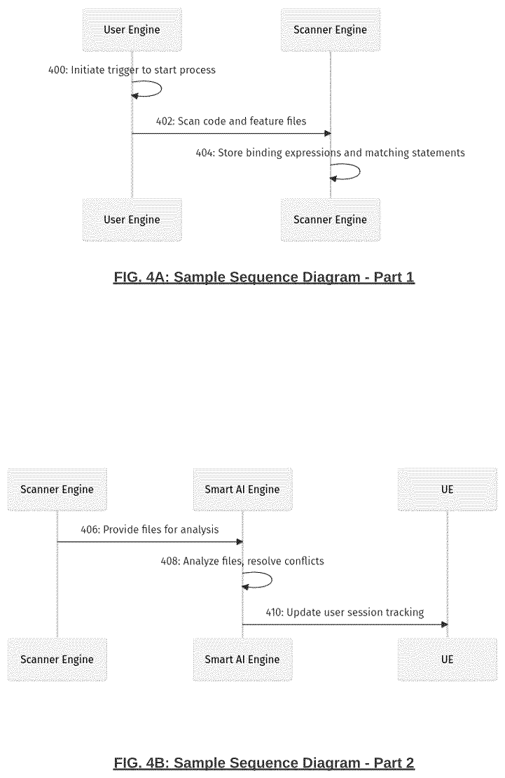

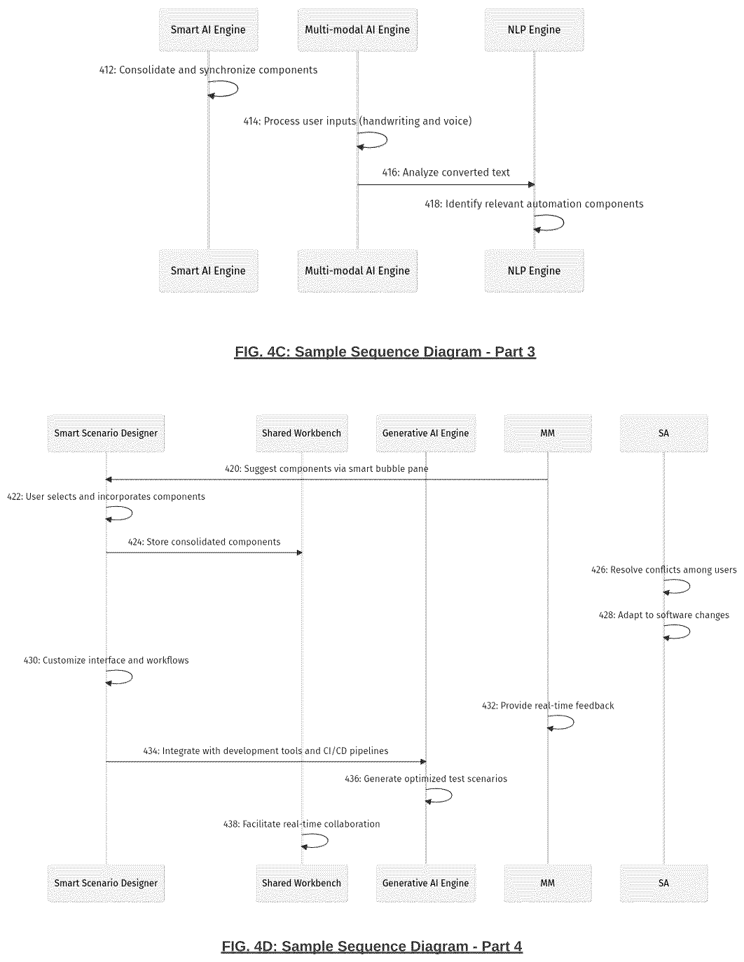

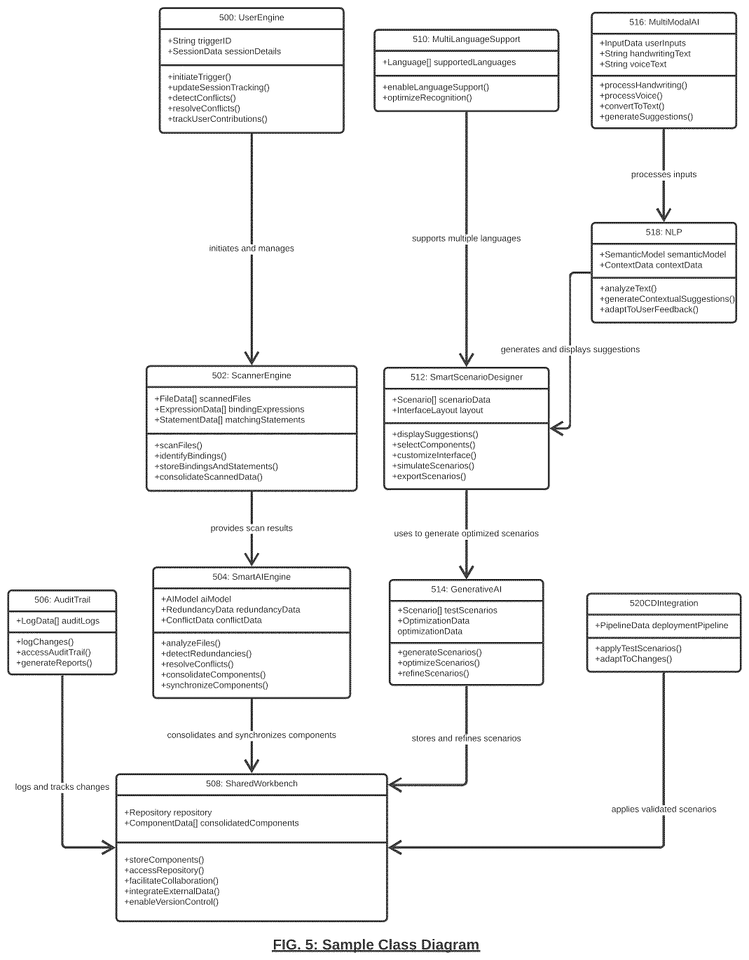

FIGS. 4A-4D are sequence diagrams that offer a comprehensive and detailed visual representation of the real-time dynamic classification and orchestration of test automation components within a distributed DevOps environment. These figures illustrate a sophisticated process flow that involves multiple components interacting seamlessly to manage and optimize the automation suite across various stages of development and testing.

In FIG. 4A, the process begins with step 400, where the user engine component initiates a trigger to start the identification and management of automated test components within the DevOps environment. This initiation is a critical first step as it sets the entire system in motion, ensuring that all subsequent processes are aligned with the overall objectives of maintaining an up-to-date and effective automation suite. The trigger activates the scanner engine component, which is depicted in step 402, where it begins the process of scanning a plurality of step definition code files and feature files. The scanner engine is meticulously designed to be tool-agnostic, script-agnostic, and language-agnostic, making it highly adaptable to different development environments and ensuring broad compatibility across various tools and languages.

During the scanning process in step 404, the scanner engine identifies binding expressions within the code files. These binding expressions are pivotal as they link business-driven requirements directly with the corresponding automation code, thereby ensuring that the automation suite accurately reflects the intended functionality of the software under test. The identified binding expressions are stored in a first file, while the matching statements extracted from the feature files are stored in a second file. These files serve as temporary repositories, as illustrated in step 406, where they organize the identified automation components systematically, preparing them for further analysis.

The sequence progresses to FIG. 4B, where in step 408, the smart AI engine component takes over to analyze the contents of the first and second files. This analysis is essential for detecting and resolving any redundancies, discrepancies, duplications, and conflicts that may exist within the automation suite. The smart AI engine employs advanced artificial intelligence techniques that continuously learn and improve over time, making the system more efficient and effective with each iteration. The learning capabilities of the AI ensure that as the system encounters new patterns or potential issues, it adapts and refines its processes to better handle similar situations in the future.

In step 410, the smart AI engine facilitates real-time consolidation and synchronization of the automation components across multiple users, ensuring that all users are working with a consistent and up-to-date version of the automation suite. This step is crucial in a distributed environment where multiple users may be contributing to or modifying the automation suite simultaneously. The AI engine's ability to synchronize these efforts in real-time helps prevent conflicts and ensures that the automation suite remains aligned with the overall testing strategy.

FIG. 4C illustrates the role of the user engine component in updating user session tracking details, as shown in step 412. This tracking is vital for monitoring and logging user activities across different sessions and users. By keeping a detailed record of these activities, the system can detect potential conflicts in a multi-user environment and ensure that all users are working with the most current automation components. The user engine component's tracking capabilities are particularly important for maintaining the integrity of the automation suite in environments where multiple users may be working on different aspects of the suite concurrently.

As the sequence continues in FIG. 4D, step 414 shows the multi-modal AI engine component processing user inputs in the form of free-form handwriting and voice. This component converts these inputs into text in real-time using advanced handwriting recognition and voice recognition technologies. The conversion process is optimized to handle variations in handwriting styles, speech patterns, accents, and dialects, ensuring that the system can accurately interpret a wide range of user inputs. The converted text is then analyzed by the NLP engine in step 416 to identify relevant automation components based on the context of the user input. This analysis allows the system to generate contextually appropriate suggestions for inclusion in the test scenario.

In step 418, the multi-modal AI engine dynamically suggests relevant automation components through a smart bubble pane displayed on the smart scenario designer interface. This interface provides users with an interactive and intuitive environment for scenario creation, allowing them to select and incorporate the suggested automation components into the test scenario in real-time. The smart bubble pane is continuously updated as the user writes or speaks, ensuring that the suggestions remain relevant to the current context of the scenario being developed.

The process continues with step 420, where the shared workbench engine component stores the consolidated and updated automation components in a centralized repository. This repository is accessible to all users across the distributed environment, ensuring that the most current and relevant automation components are always available for use. The centralized nature of this repository is critical for maintaining consistency across the automation suite, particularly in environments where multiple users may be working on different parts of the suite at the same time.

Step 422 highlights the smart AI engine's capability to enable real-time conflict resolution among multiple users. When conflicts arise, the smart AI engine detects them and facilitates the necessary human intervention to resolve these issues. This step is particularly important in a distributed environment where multiple users may be making simultaneous changes to the automation suite, as it helps to ensure that the suite remains accurate and up-to-date despite these concurrent modifications.

As the system adapts to changes in the software under test, step 424 shows the smart AI engine continuously learning from user inputs, feedback, and changes in the software environment. This continuous learning process ensures that the automation components remain relevant and effective over time, even as the software being tested evolves. The ability of the smart AI engine to adapt to these changes is a key factor in maintaining the long-term viability and effectiveness of the automation suite.

In step 426, the smart scenario designer interface enables users to customize the layout, tools, and workflows to suit their individual preferences. This customization capability allows for personalized user experiences and improved productivity, as users can tailor the interface to better fit their specific needs and workflows. The system also provides real-time feedback to users on the impact of their inputs on the test scenarios being authored, as shown in step 428. This feedback includes suggestions for improvements and optimizations, helping users to refine their scenarios and achieve better results.

Finally, in step 430, the system integrates the smart scenario designer interface with various development tools, CI/CD pipelines, and environments. This integration ensures compatibility and seamless workflow integration across the DevOps lifecycle, allowing users to deploy their test scenarios with confidence. The generative AI component, depicted in step 432, generates optimized test scenarios based on the user's input, historical data, and the context of the software under test. These scenarios are refined to maximize test scope and efficiency, ensuring that the most critical aspects of the software are thoroughly tested.

The sequence concludes with step 434, where the shared workbench engine component facilitates real-time collaboration among multiple users. This collaboration is essential in distributed teams, as it ensures that all team members have access to the most current and relevant automation components, regardless of their location or time zone. The ability to collaborate in real-time across distributed environments is a key feature of the system, enhancing both the efficiency and effectiveness of the automation process.

These sequence diagrams collectively depict a robust and highly adaptable system that is capable of managing and optimizing test automation components in a dynamic and distributed DevOps environment. The detailed interactions between the various components ensure that the system remains consistent, up-to-date, and aligned with the overall testing strategy, even as the software under test evolves and multiple users contribute to the automation suite. The system's ability to learn, adapt, and provide real-time feedback and conflict resolution makes it a powerful tool for ensuring the long-term success of automated testing efforts in complex and distributed environments.

FIG. 5 is a class diagram that is a comprehensive and detailed representation of the system designed for real-time dynamic classification and orchestration of test automation components within a distributed DevOps environment. This diagram intricately captures the relationships and interactions between various components of the system, each represented as a class with specific attributes and methods that define its functionality and role within the broader system. The diagram serves as a visual roadmap, illustrating how these components collaborate to achieve the system's objectives.

At the core of the system is the UserEngine class, identified as 500 in the figure. This class is the central hub for initiating and managing the entire process of identifying, tracking, and managing automated test components. The UserEngine class is equipped with several key attributes, such as ‘triggerID’, a unique identifier that initiates the process, and ‘sessionDetails’, which contains information about the user sessions. These attributes are crucial for ensuring that the system can effectively monitor and log user activities across different sessions. The methods associated with the UserEngine class, including ‘initiateTrigger( )’, ‘updateSessionTracking( )’, ‘detectConflicts( )’, ‘resolveConflicts( )’, and ‘trackUserContributions( )’, form the backbone of the system's ability to manage and resolve conflicts, track user contributions, and ensure that all users are working with the most current and accurate information. This class plays a pivotal role in maintaining the integrity and coherence of the automation suite in a distributed environment, where multiple users may be contributing to or modifying the suite simultaneously.

The ScannerEngine class, labeled as 502, is responsible for the critical task of scanning a plurality of step definition code files and feature files within the automation suite. This class is designed to be tool-agnostic, script-agnostic, and language-agnostic, ensuring its compatibility with a wide range of development environments. The attributes of the ScannerEngine class, such as ‘scannedFiles’, ‘bindingExpressions’, and ‘matchingStatements’, represent the data that is processed during the scanning operation. These attributes store the files that have been scanned, the binding expressions that have been identified, and the corresponding matching statements from the feature files. The methods ‘scanFiles( )’, ‘identifyBindings( )’, ‘storeBindingsAndStatements( )’, and ‘consolidateScannedData( )’ are responsible for retrieving and processing these files, identifying the critical binding expressions that link business-driven requirements with the corresponding automation code, and ensuring that these expressions are accurately stored and organized. The ScannerEngine class is essential for laying the groundwork for subsequent analysis and processing by other components in the system.

Once the scanning process is complete, the SmartAIEngine class, labeled as 504, takes over to perform an in-depth analysis of the scanned files. The SmartAIEngine class is equipped with advanced artificial intelligence techniques that continuously learn and improve based on historical data and user feedback. The attributes ‘aiModel’, ‘redundancyData’, and ‘conflictData’ store the AI model used for analysis, as well as information about any redundancies or conflicts detected within the automation suite. The methods ‘analyzeFiles( )’, ‘detectRedundancies( )’, ‘resolveConflicts( )’, ‘consolidateComponents( )’, and ‘synchronizeComponents( )’ ensure that the system can detect and resolve redundancies, discrepancies, duplications, and conflicts within the suite, maintaining its consistency and effectiveness. The SmartAIEngine class is crucial for ensuring that all components within the shared workbench are aligned with the overall testing strategy and are up-to-date, even as the software under test evolves.

The MultiModalAI class, identified as 516, is responsible for processing user inputs, which may be in the form of free-form handwriting or voice commands. This class is equipped with attributes such as ‘userInputs’, ‘handwritingText’, and ‘voiceText’, which capture the raw input data and store the converted text from these inputs. The methods ‘processHandwriting( )’, ‘processVoice( )’, ‘convertToText( )’, and ‘generateSuggestions( )’ are designed to handle the complex task of converting these inputs into text, analyzing them, and generating relevant suggestions for automation components. These suggestions are then displayed to the user in real-time, ensuring that the user interface remains responsive and interactive.

The NLP class, labeled as 518, works closely with the MultiModalAI class to further analyze the converted text and generate contextually appropriate suggestions. The attributes ‘semanticModel’ and ‘contextData’ represent the underlying semantic analysis model and the contextual information that guides the NLP engine's decision-making process. The methods ‘analyzeText( )’, ‘generateContextualSuggestions( )’, and ‘adaptToUserFeedback( )’ ensure that the system remains effective in interpreting and responding to user inputs, continuously refining its suggestions based on historical data and user feedback.

The SmartScenarioDesigner class, labeled as 512, is the primary interface through which users interact with the system to create and manage test scenarios. This class includes attributes such as ‘scenarioData’, which stores the scenarios being worked on, and ‘layout’, which defines the interface's visual and functional layout. The methods ‘displaySuggestions( )’, ‘selectComponents( )’, ‘customizeInterface( )’, ‘simulateScenarios( )’, and ‘exportScenarios( )’ provide a comprehensive set of tools that enable users to easily input, modify, and organize test scenarios. The SmartScenarioDesigner class is crucial for providing a user-friendly and intuitive environment that enhances productivity and user satisfaction.

The SharedWorkbench class, labeled as 508, serves as the central repository for storing the consolidated and synchronized automation components. This class includes attributes such as ‘repository’, which is the storage location, and ‘consolidatedComponents’, which holds the updated components. The methods ‘storeComponents( )’, ‘accessRepository( )’, ‘facilitateCollaboration( )’, ‘integrateExternalData( )’, and ‘enable VersionControl( )’ enable real-time collaboration among users, ensuring that all team members have access to the most current and relevant automation components, regardless of their location or time zone. The SharedWorkbench class plays a critical role in maintaining the consistency and integrity of the automation suite across the distributed environment.

The GenerativeAI class, labeled as 514, is responsible for generating optimized test scenarios based on user input, historical data, and the context of the software under test. The attributes ‘testScenarios’ and ‘optimizationData’ represent the scenarios generated by the AI and the optimization data used to refine these scenarios. The methods ‘generateScenarios( )’, ‘optimizeScenarios( )’, and ‘refineScenarios( )’ ensure that the generated scenarios are refined to maximize test coverage and efficiency, aligning with the overall testing strategy.

The CDIntegration class, labeled as 520, integrates the system with continuous deployment (CD) pipelines. The attributes of this class include ‘deploymentPipeline’, which represents the data related to the deployment process. The methods ‘applyTestScenarios( )’ and ‘adaptToChanges( )’ ensure that validated scenarios are seamlessly integrated into the production environment as part of the CI/CD process, maintaining alignment with ongoing development and deployment activities.

The MultiLanguageSupport class, labeled as 510, provides support for multiple languages within the system, ensuring that the system can accurately recognize and process inputs across different linguistic contexts. The attributes ‘supportedLanguages’ represent the languages the system can handle, while the methods ‘enableLanguageSupport( )’ and ‘optimizeRecognition( )’ ensure that the system remains inclusive and accessible to a diverse range of users.

Finally, the AuditTrail class, labeled as 506, is responsible for maintaining a comprehensive audit trail of all changes made to test scenarios. The attributes ‘auditLogs’ store the logs of all changes, while the methods ‘logChanges( )’, ‘accessAuditTrail( )’, and ‘generateReports( )’ ensure that all modifications are tracked and recorded, providing transparency, accountability, and traceability throughout the DevOps environment. This class is essential for compliance, quality assurance, and collaborative decision-making within the system.

In conclusion, the class diagram in FIG. 5 provides an in-depth visual representation of the system's architecture, highlighting the detailed interactions between its components. Each class is carefully designed to fulfill specific roles within the system, ensuring that the overall process of dynamic classification and orchestration of test automation components is efficient, adaptable, and robust. The diagram not only illustrates the relationships between these components but also underscores the complexity and sophistication of the system, which is capable of operating effectively in a distributed and dynamic DevOps environment.

Pseudocode examples to implement one or more aspects of the inventions disclosed herein can be considered as follows.
# Initialize the system components
initialize_system_components( )
# Start by the user engine initiating a trigger
function initiate_trigger( )
   trigger_id=generate_trigger_id( )
   log_event(“Trigger initiated with ID:”+trigger_id)
   start_identification_process(trigger_id)
# Function to start the identification process
function start_identification_process(trigger_id):
   scan_results=scanner_engine_scan_files( )
   binding_expressions, matching_statements=analyze_scan_results(scan_results)
   store_bindings_and_statements(binding_expressions, matching_statements)
   analyze_files_with_smart_AI(binding_expressions, matching_statements)
   update_user_sessions( )
   consolidate_components_real_time( )
   process_user_inputs( )
   synchronize_components( )
# Scanner engine scans the files
function scanner_engine_scan_files( ):
   files=retrieve_step_definition_files( )
   feature_files=retrieve_feature_files( )
   scan_results=[ ]
   for file in files:
      scan_results.append(scan_file(file))
   for feature_file in feature_files:
      scan_results.append(scan_feature_file(feature_file))
   return scan_results
# Analyze the scanned files and extract binding expressions and matching statements
function analyze_scan_results(scan_results):
   binding_expressions=[ ]
   matching_statements=[ ]
   for result in scan_results:
      bindings=extract_bindings(result)
      statements=extract_matching_statements(result)
      binding_expressions.extend(bindings)
      matching_statements.extend(statements)
   return binding_expressions, matching_statements
# Store the identified bindings and matching statements in temporary files
function store_bindings_and_statements(bindings, statements):
   store_in_file(bindings, “binding_expressions.txt”)
   store_in_file(statements, “matching_statements.txt”)
# Smart AI engine analyzes the files to detect and resolve conflicts
function analyze_files_with_smart_AI(bindings, statements):
   redundant_bindings=detect_redundancies(bindings)
   conflicts=detect_conflicts(statements)
   resolve_conflicts(conflicts)
   log_event(“Redundancies resolved and conflicts addressed”)
# Update user sessions with tracking details
function update_user_sessions( ):
   sessions=retrieve_active_sessions( )
   for session in sessions:
      update_tracking_details(session)
   log_event(“User sessions updated with the latest tracking details”)
# Facilitate real-time consolidation and synchronization
function consolidate_components_real_time( ):
   components=retrieve_updated_components( )
   synchronized_components=synchronize_across_users(components)
   store_consolidated_components(synchronized_components)
   log_event(“Components consolidated and synchronized in real-time”)
# Process user inputs (handwriting and voice)
function process_user_inputs( ):
   user_inputs=capture_user_inputs( )
   processed_text=convert_to_text(user_inputs)
   suggestions=generate_suggestions(processed_text)
   display_suggestions(suggestions)
# Synchronize components across users
function synchronize_components( ):
   current_components=retrieve_current_components( )
   synchronized_components=synchronize_across_users(current_components)
   store_consolidated_components(synchronized_components)
   log_event(“Components synchronized across users”)
# Capture and convert user inputs
function capture_user_inputs( ):
   handwriting_input=capture_handwriting( )
   voice_input=capture_voice( )
   return handwriting_input, voice_input
# Convert user inputs to text
function convert_to_text(inputs):
   handwriting_text=handwriting_to_text(inputs.handwriting_input)
   voice_text=voice_to_text(inputs.voice_input)
   return combine_text(handwriting_text, voice_text)
# Generate suggestions based on processed text
function generate_suggestions(processed_text):
   relevant_components=identify_relevant_components(processed_text)
   suggestions=generate_contextual_suggestions(relevant_components)
   return suggestions
# Display suggestions to the user in real-time
function display_suggestions(suggestions):
   smart_bubble_pane=retrieve_smart_bubble_pane( )
   update_smart_bubble_pane(smart_bubble_pane, suggestions)
   log_event(“Suggestions displayed in real-time to the user”)
# Handle synchronization of components across all users
function synchronize_across_users(components):
   updated_components=[ ]
   for component in components:
      updated_component=check_for_updates(component)
      updated_components.append(updated_component)
   return updated_components
# Store consolidated and synchronized components
function store_consolidated_components(components):
   store_in_repository(components)
   log_event(“Consolidated and synchronized components stored successfully”)

The pseudocode provided represents a comprehensive and detailed implementation of the system described in the invention, covering all key aspects necessary for the real-time dynamic classification and orchestration of test automation components within a distributed DevOps environment. This implementation begins with the initialization of system components, which is a critical step in setting up the environment where all subsequent operations will take place. This initialization process ensures that each component, such as the user engine, scanner engine, smart AI engine, multi-modal AI engine, and NLP engine, is prepared and configured to carry out its designated tasks effectively.

The core functionality of the system is triggered by the user engine component through the initiate_trigger( ) function. This function generates a unique trigger ID, which serves as a reference point for the entire process. The initiation of the trigger is logged to maintain a detailed record of the system's activities, ensuring transparency and traceability. Once the trigger is initiated, the start_identification_process( ) function is called, which orchestrates the various tasks involved in identifying and managing the automated test components within the DevOps environment.

The identification process begins with the scanner engine component scanning the step definition files and feature files. This scanning is performed by the scanner_engine_scan_files( ) function, which systematically retrieves the relevant files from the system. The scanner engine is designed to be tool-agnostic, script-agnostic, and language-agnostic, meaning it can operate across different development environments, supporting a wide variety of tools and languages. This adaptability is crucial in a DevOps environment where diverse technologies are often employed. The scanner engine processes each file to identify binding expressions-key elements that link business-driven requirements to the corresponding automation code. These binding expressions are essential for ensuring that the automation suite aligns with the intended functionality of the software being tested.

After the scanner engine completes its task, the system moves on to analyzing the scan results. This is accomplished by the analyze_scan_results( ) function, which extracts both the binding expressions and the matching statements from the scan results. These elements are then stored in temporary files for further processing. The temporary storage of these elements allows for a structured organization of the data, making it easier to analyze and resolve any issues in subsequent steps.

The smart AI engine then takes over to perform a detailed analysis of the contents of these files, as implemented in the analyze_files_with_smart_AI( ) function. This analysis is crucial for detecting and resolving any redundancies, discrepancies, duplications, and conflicts within the automation suite. The smart AI engine leverages advanced artificial intelligence techniques that are capable of continuous learning and improvement. As the system encounters new patterns or issues, it adapts and refines its processes, becoming more efficient and effective over time. This capability ensures that the automation suite remains robust and aligned with the overall testing strategy, even as the software under test evolves and new challenges arise.

Following the analysis, the system updates user session tracking details through the update_user_sessions( ) function. This update is vital for maintaining an accurate and up-to-date log of user activities across different sessions. In a multi-user environment, where multiple contributors might be working on the same automation suite simultaneously, it is crucial to track these activities meticulously to avoid conflicts and ensure that all users are working with the most current information. The system retrieves active sessions and updates them with the latest tracking details, which helps to maintain the integrity of the automation suite.

The system then facilitates the real-time consolidation and synchronization of automation components across all users, as implemented in the consolidate_components_real_time( ) function. This function ensures that all users have access to the most current and accurate version of the automation components.

The system retrieves the updated components, synchronizes them across users, and stores the consolidated components back into the system's repository. This real-time synchronization is particularly important in a distributed environment where users might be working across different locations and time zones. By ensuring that all users are working with the same set of components, the system helps to prevent conflicts and inconsistencies that could otherwise arise.

User inputs, which may include free-form handwriting and voice commands, are processed by the process_user_inputs( ) function. The system captures these inputs using specialized technologies designed to recognize and convert handwriting and voice into text. This conversion process is optimized to handle variations in handwriting styles, speech patterns, accents, and dialects, ensuring that the system can accurately interpret a wide range of inputs. Once converted, the text is analyzed by the NLP engine to identify relevant automation components based on the context of the user's input. The NLP engine's analysis allows the system to generate contextually appropriate suggestions for automation components, which are then dynamically displayed to the user through a smart bubble pane on the smart scenario designer interface.

The smart bubble pane is an interactive feature that allows users to view and select suggestions in real-time. This interface is continuously updated to reflect the current context of the scenario being developed, ensuring that the suggestions provided are always relevant and timely. The system's ability to process user inputs in real-time and provide immediate feedback through the smart bubble pane enhances the user experience and allows for more efficient scenario creation and management.

Finally, the system ensures that all automation components are synchronized across all users by repeatedly checking for updates. This synchronization process, handled by the synchronize_across_users( ) and store_consolidated_components( ) functions, ensures that the most current version of each component is available to all users. The process is meticulously logged at each step to maintain a clear and detailed record of all actions, providing transparency and ensuring that the system operates efficiently.

The pseudocode implementation provided represents a detailed and structured sequence of operations designed to achieve the successful orchestration and management of test automation components in a distributed DevOps environment. Each function within the pseudocode plays a critical role in ensuring that the system operates smoothly and effectively, adapting to changes and providing real-time feedback to users. This implementation not only supports the creation and management of automated test components but also ensures that the automation suite remains consistent, up-to-date, and aligned with the overall testing strategy, even in a complex and distributed environment.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The present disclosure encompasses a vast range of additional embodiments, variations, modifications, and improvements that can significantly enhance the system and method described, catering to the diverse needs of users across different industries and environments. For example, the system can be adapted to support more advanced and intuitive input methods beyond handwriting and voice. Gesture-based controls, where users can interact with the Smart Scenario Designer interface using hand movements, could be integrated into the system. This could be particularly useful in environments where physical interaction with devices is limited or where touchless controls are preferred. Additionally, the integration of augmented reality (AR) interfaces could allow users to visualize and manipulate automation components in a three-dimensional space, providing a more immersive and interactive experience. This AR capability could extend to visualizing complex automation workflows in real-time, making it easier for users to understand and optimize their automation strategies.

The AI components within the system can also be expanded to include advanced predictive analytics, enabling the system to proactively identify potential issues in test scenarios before they become problematic. For instance, by analyzing patterns in historical data, the AI could predict the likelihood of certain test scenarios failing and suggest modifications to improve their robustness. This predictive capability could also extend to resource allocation, where the system anticipates the computational resources needed for testing and adjusts allocations dynamically to ensure optimal performance. Such predictive analytics could greatly enhance the efficiency and reliability of the automation process, reducing downtime and improving overall productivity.

Another significant modification could involve integrating blockchain technology into the system. Blockchain could be used to create an immutable ledger of all changes made to test scenarios, ensuring that every modification is securely recorded and cannot be tampered with. This would enhance the transparency and security of the automation process, making it particularly valuable in industries where data integrity and traceability are critical, such as finance and government sectors. The blockchain ledger could also be used to enforce compliance with regulatory requirements by providing an auditable trail of all changes made to test scenarios.

The system's versatility can be further enhanced by expanding its support for a broader range of development environments, programming languages, and frameworks. This could include compatibility with newer and emerging technologies, ensuring that the system remains relevant and adaptable in rapidly evolving technological landscapes. By supporting a wider array of tools and languages, the system can cater to the specific needs of different industries, from software development and IT operations to manufacturing and robotics. This flexibility would allow organizations to integrate the system seamlessly into their existing workflows, minimizing disruptions and maximizing the benefits of automation.

Improvements to the smart AI engine could involve the incorporation of more sophisticated machine learning models that better understand and adapt to the unique workflows and processes of different organizations. These models could be trained on industry-specific data, enabling the AI to provide more targeted and effective automation solutions. For example, in a financial services organization, the AI could learn to prioritize test scenarios that focus on compliance and risk management, while in a manufacturing environment, it might prioritize scenarios that ensure the reliability and safety of production systems. By tailoring the AI's capabilities to the specific needs of different industries, the system could provide more relevant and impactful automation outcomes.

Collaborative AI models could be another powerful enhancement, allowing multiple instances of the system to work together across different geographical locations. This would be particularly beneficial for global DevOps teams that need to coordinate their efforts across time zones and regions. Collaborative AI could facilitate real-time sharing of automation components and test scenarios, ensuring that all team members are working with the most up-to-date information. It could also enable distributed AI processing, where complex tasks are divided among multiple AI engines located in different regions, reducing processing times and improving overall system performance.

The system could also be improved with advanced reporting and visualization tools that provide users with deeper insights into the performance and effectiveness of their test scenarios. These tools could include real-time dashboards that display key metrics and analytics, customizable reports that allow users to focus on specific aspects of their automation processes, and detailed visualizations that help users understand the impact of different scenarios on their overall testing strategy. For example, heat maps could be used to highlight areas of the automation process that are particularly resource-intensive or prone to failure, enabling users to target their optimization efforts more effectively. These reporting and visualization tools would not only enhance the user experience but also empower organizations to make more informed and strategic decisions about their automation processes.

Furthermore, the system could be modified to support continuous learning and adaptation based on user feedback and evolving requirements. This could involve implementing feedback loops where the system actively learns from the outcomes of executed test scenarios, making adjustments to improve future performance. For example, if a particular test scenario consistently fails or underperforms, the system could analyze the reasons for this and suggest modifications to enhance its effectiveness. This continuous learning capability would ensure that the system remains responsive to the changing needs of the organization, evolving alongside technological advancements and new business challenges.

In addition to these enhancements, the system could also be designed to integrate seamlessly with other enterprise systems and tools, such as customer relationship management (CRM) systems, enterprise resource planning (ERP) systems, and cloud-based data storage solutions. This would enable organizations to leverage the full potential of their existing technology stack, creating a more cohesive and efficient operational environment. For example, integrating the system with a CRM platform could allow for the automation of customer-facing processes, such as automated testing of customer support workflows or sales processes, ensuring that these critical functions are operating at peak efficiency.

All of these additional embodiments, variations, modifications, and improvements are within the scope and spirit of the present disclosure and should be considered as part of the invention. Skilled artisans will recognize that these examples represent just a few of the many potential ways in which the disclosed system and method can be adapted and enhanced to meet the specific needs of different users and applications. The flexibility and adaptability of the system ensure that it can evolve alongside technological advancements and changing industry requirements, maintaining its relevance and effectiveness over time. These enhancements not only expand the system's capabilities but also demonstrate its potential to revolutionize automation processes across various sectors, providing robust, scalable, and intelligent solutions that drive efficiency, accuracy, and innovation.

1. A method for real-time dynamic classification and orchestration of test automation components in a distributed DevOps environment, the method comprising:
initiating, by a user engine component, a trigger to start a process of identifying and managing automated test components within a distributed DevOps environment;
scanning, by a scanner engine component, a plurality of step definition code files and feature files to identify binding expressions, wherein the scanner engine component is tool-agnostic, script-agnostic, and language-agnostic, and is configured to focus specifically on binding expressions that link business-driven requirements with corresponding automation code;
storing, by the scanner engine component, the identified binding expressions in a first file and the corresponding matching statements from the feature files in a second file, wherein these files serve as temporary repositories for the identified automation components;
analyzing, by a smart AI engine component, contents of the first and second files to detect and resolve redundancies, discrepancies, duplications, and conflicts within an automation suite, utilizing advanced artificial intelligence techniques that continuously learn and improve over time;
updating, by the user engine component, user session tracking details to monitor and log user activities, wherein the user engine component is configured to detect potential conflicts in a multi-user environment and to ensure that all users are working with the most current automation components;
facilitating, by the smart AI engine component, real-time consolidation and synchronization of automation components across multiple users, ensuring that all components are consistent and up-to-date within a shared workbench;
processing, by a multi-modal AI engine component, user inputs in a form of free-form handwriting and voice, converting these inputs into text in real-time using handwriting recognition and voice recognition technologies, wherein a conversion process is optimized to handle variations in handwriting and speech patterns;
analyzing, by a natural language processing (NLP) engine, the converted text to identify relevant automation components based on context of the user input, and generating contextually appropriate suggestions for inclusion in a test scenario;
dynamically suggesting, by the multi-modal AI engine component, relevant automation components via a smart bubble pane displayed on a smart scenario designer interface, wherein the smart bubble pane is continuously updated in real-time as the user writes or speaks;
allowing, by the smart scenario designer interface, the user to select and incorporate the suggested automation components into the test scenario in real-time, providing an interactive and intuitive environment for scenario creation;
storing, by a shared workbench engine component, the consolidated and updated automation components in a centralized repository, ensuring that these components are accessible to all users across the distributed environment;
enabling, by the smart AI engine component, real-time conflict resolution among multiple users by detecting potential conflicts in the automation suite and facilitating human intervention when necessary;
adapting, by the smart AI engine component, to changes in software under test by continuously learning from user inputs, feedback, and changes in a software environment, ensuring that the automation components remain relevant and effective;
enabling, by the smart scenario designer interface, customization of an interface layout, tools, and workflows to suit individual user preferences, allowing for personalized user experiences and improved productivity;
providing, by the multi-modal AI engine component, real-time feedback to users on impact of their inputs on test scenarios being authored, including suggestions for improvements and optimizations;
integrating, by a system, the smart scenario designer interface with various development tools, continuous integration/continuous deployment (CI/CD) pipelines, and environments, ensuring compatibility and seamless workflow integration across a DevOps lifecycle;
generating, by a generative AI component, optimized test scenarios based on the user's input, historical data, and the context of the software under test, wherein the generated scenarios are refined to maximize test scope and efficiency; and
facilitating, by the shared workbench engine component, real-time collaboration among multiple users by ensuring that all users have access to the most current and relevant automation components, supporting distributed teams working across different locations and time zones.

2. The method of claim 1, further comprising updating, by the smart AI engine component, the shared workbench engine component with newly identified and validated automated components, ensuring that the repository is continuously enriched with the latest automation scripts.

3. The method of claim 2, further comprising resolving, by the user engine component, conflicts that require human intervention by connecting relevant users through the smart scenario designer interface to collaboratively address the identified issues, thereby minimizing delays and ensuring continuity in automation processing.

4. The method of claim 3, further comprising prioritizing, by the multi-modal AI engine component, the automated components suggested in the smart bubble pane based on a specific module, feature, or priority level of the software being tested, ensuring that the most critical components are highlighted for user selection.

5. The method of claim 4, further comprising enabling, by the smart scenario designer interface, drag-and-drop functionality for reordering, restructuring, and organizing test scenarios, allowing users to easily adjust sequence and hierarchy of test steps to optimize testing.

6. The method of claim 5, further comprising providing, by the multi-modal AI engine component, detailed analytics and reports to the user on the effectiveness, efficiency, and scope of created test scenarios, including metrics on execution time, resource utilization, and defect detection rates.

7. The method of claim 6, further comprising allowing, by the smart scenario designer interface, customization of voice input settings to adapt to different accents, dialects, and speech patterns, enhancing the system's accuracy and usability for diverse user groups.

8. The method of claim 7, further comprising automatically adjusting, by the smart AI engine component, frequency and granularity of real-time updates and suggestions based on complexity of the test scenario, the user's preferences, and current state of the automation suite.

9. The method of claim 8, further comprising integrating, by the system, external data sources, such as third-party APIs, databases, and cloud services, into the shared workbench engine component to enhance the relevance and accuracy of the automation component suggestions provided to users.

10. The method of claim 9, further comprising tracking, by the user engine component, contributions and modifications made by each user to the test scenarios, providing a detailed audit trail for accountability, version control, and collaborative decision-making.

11. The method of claim 10, further comprising enabling, by the smart scenario designer interface, export of test scenarios into multiple formats, such as XML, JSON, or script files, compatible with various automation frameworks and tools, allowing seamless integration with existing systems.

12. The method of claim 11, further comprising adapting, by the smart AI engine component, the NLP processing rules and algorithms based on historical data and user feedback, continuously improving the system's ability to interpret and generate relevant automation components.

13. The method of claim 12, further comprising allowing, by the smart scenario designer interface, real-time simulation and preview of test scenarios to visualize potential outcomes and identify issues before the scenarios are finalized and executed, reducing risk of defects and inefficiencies.

14. The method of claim 13, further comprising integrating, by the smart AI engine component, continuous deployment (CD) tools and services, enabling the system to automatically apply validated and approved test scenarios to the production environment as part of the CI/CD pipeline.

15. The method of claim 14, further comprising enabling, by the system, multi-language support for the smart scenario designer interface, allowing global teams to author and manage test scenarios in their preferred languages, facilitating collaboration across diverse, international teams.

16. The method of claim 15, further comprising providing, by the smart AI engine component, advanced recommendations for optimizing test scenarios, such as suggesting alternative automation components, refining test data inputs, or adjusting test execution parameters based on machine learning insights and patterns derived from past scenarios.

17. The method of claim 16, further comprising enabling, by the shared workbench engine component, version control for the automated components stored in the repository, allowing users to track changes over time, compare different versions, and revert to previous versions if necessary to maintain the integrity and reliability of the automation suite.

18. The method of claim 17, further comprising providing, by the multi-modal AI engine component, a comprehensive audit trail that logs all changes made to test scenarios, including the identity of the user who made the changes, rationale for the modifications, and impact on the overall automation suite, ensuring transparency and traceability throughout the automation process.

19. A method for real-time dynamic classification and orchestration of test automation components in a distributed DevOps environment, the method comprising:
initiating, by a user engine component, a trigger to start the process of identifying and managing automated test components within a distributed DevOps environment;
scanning, by a scanner engine component, a plurality of step definition code files and feature files to identify binding expressions, wherein the scanner engine component is tool-agnostic, script-agnostic, and language-agnostic, and is configured to focus specifically on binding expressions that link business-driven requirements with corresponding automation code;
storing, by the scanner engine component, the identified binding expressions in a first file and the corresponding matching statements from the feature files in a second file, wherein these files serve as temporary repositories for the identified automation components;
analyzing, by a smart AI engine component, contents of the first and second files to detect and resolve redundancies, discrepancies, duplications, and conflicts within an automation suite, utilizing advanced artificial intelligence techniques that continuously learn and improve over time;
updating, by the user engine component, user session tracking details to monitor and log user activities, wherein the user engine component is configured to detect potential conflicts in a multi-user environment and to ensure that all users are working with the most current automation components;
facilitating, by the smart AI engine component, real-time consolidation and synchronization of automation components across multiple users, ensuring that all components are consistent and up-to-date within a shared workbench;
processing, by a multi-modal AI engine component, user inputs in a form of free-form handwriting and voice, converting these inputs into text in real-time using handwriting recognition and voice recognition technologies, wherein a conversion process is optimized to handle variations in handwriting and speech patterns;
analyzing, by a natural language processing (NLP) engine, the converted text to identify relevant automation components based on context of the user input, and generating contextually appropriate suggestions for inclusion in a test scenario;
dynamically suggesting, by the multi-modal AI engine component, relevant automation components via a smart bubble pane displayed on a smart scenario designer interface, wherein the smart bubble pane is continuously updated in real-time as the user writes or speaks;
allowing, by the smart scenario designer interface, the user to select and incorporate the suggested automation components into the test scenario in real-time, providing an interactive and intuitive environment for scenario creation;
storing, by a shared workbench engine component, the consolidated and updated automation components in a centralized repository, ensuring that these components are accessible to all users across the distributed environment;
enabling, by the smart AI engine component, real-time conflict resolution among multiple users by detecting potential conflicts in the automation suite and facilitating human intervention when necessary;
adapting, by the smart AI engine component, to changes in software under test by continuously learning from user inputs, feedback, and changes in a software environment, ensuring that the automation components remain relevant and effective;
enabling, by the smart scenario designer interface, customization of an interface layout, tools, and workflows to suit individual user preferences, allowing for personalized user experiences and improved productivity;
providing, by the multi-modal AI engine component, real-time feedback to users on impact of their inputs on test scenarios being authored, including suggestions for improvements and optimizations;
integrating, by a system, the smart scenario designer interface with various development tools, continuous integration/continuous deployment (CI/CD) pipelines, and environments, ensuring compatibility and seamless workflow integration across a DevOps lifecycle;
generating, by a generative AI component, optimized test scenarios based on the user's input, historical data, and the context of the software under test, wherein the generated scenarios are refined to maximize test scope and efficiency;
facilitating, by the shared workbench engine component, real-time collaboration among multiple users by ensuring that all users have access to the most current and relevant automation components, supporting distributed teams working across different locations and time zones;
updating, by the smart AI engine component, the shared workbench engine component with newly identified and validated automated components, ensuring that the repository is continuously enriched with the latest automation scripts;
resolving, by the user engine component, conflicts that require human intervention by connecting relevant users through the smart scenario designer interface to collaboratively address the identified issues, thereby minimizing delays and ensuring continuity in the automation process;
prioritizing, by the multi-modal AI engine component, the automated components suggested in the smart bubble pane based on a specific module, feature, or priority level of the software being tested, ensuring that the most critical components are highlighted for user selection;
enabling, by the smart scenario designer interface, drag-and-drop functionality for reordering, restructuring, and organizing test scenarios, allowing users to easily adjust sequence and hierarchy of test steps to optimize testing;
providing, by the multi-modal AI engine component, detailed analytics and reports to the user on the effectiveness, efficiency, and scope of created test scenarios, including metrics on execution time, resource utilization, and defect detection rates;
allowing, by the smart scenario designer interface, customization of voice input settings to adapt to different accents, dialects, and speech patterns, enhancing the system's accuracy and usability for diverse user groups;
automatically adjusting, by the smart AI engine component, frequency and granularity of real-time updates and suggestions based on complexity of the test scenario, the user's preferences, and current state of the automation suite;
integrating, by the system, external data sources, such as third-party APIs, databases, and cloud services, into the shared workbench engine component to enhance the relevance and accuracy of the automation component suggestions provided to users;
tracking, by the user engine component, contributions and modifications made by each user to the test scenarios, providing a detailed audit trail for accountability, version control, and collaborative decision-making;
enabling, by the smart scenario designer interface, export of test scenarios into multiple formats, such as XML, JSON, or script files, compatible with various automation frameworks and tools, allowing seamless integration with existing systems;
adapting, by the smart AI engine component, the NLP processing rules and algorithms based on historical data and user feedback, continuously improving the system's ability to interpret and generate relevant automation components;
allowing, by the smart scenario designer interface, real-time simulation and preview of test scenarios to visualize potential outcomes and identify issues before the scenarios are finalized and executed, reducing risk of defects and inefficiencies;
integrating, by the smart AI engine component, continuous deployment (CD) tools and services, enabling the system to automatically apply validated and approved test scenarios to the production environment as part of the CI/CD pipeline;
enabling, by the system, multi-language support for the smart scenario designer interface, allowing global teams to author and manage test scenarios in their preferred languages, facilitating collaboration across diverse, international teams;
providing, by the smart AI engine component, advanced recommendations for optimizing test scenarios, such as suggesting alternative automation components, refining test data inputs, or adjusting test execution parameters based on machine learning insights and patterns derived from past scenarios;
enabling, by the shared workbench engine component, version control for the automated components stored in the repository, allowing users to track changes over time, compare different versions, and revert to previous versions if necessary to maintain the integrity and reliability of the automation suite;
providing, by the multi-modal AI engine component, a comprehensive audit trail that logs all changes made to test scenarios, including the identity of the user who made the changes, rationale for the modifications, and the impact on the overall automation suite, ensuring transparency and traceability throughout the automation process; and
facilitating, by the smart AI engine component, automatic updates to the automation components and test scenarios based on continuous integration and deployment feedback, thereby ensuring that the automation suite evolves in alignment with the ongoing development process.

20. A system for real-time dynamic classification and orchestration of test automation components in a distributed DevOps environment, the system comprising:
a user engine component configured to:
initiate a trigger to start a process of identifying, tracking, and managing automated test components within a distributed DevOps environment;
update user session tracking details to monitor and log user activities across multiple sessions and users;
detect potential conflicts arising in a multi-user environment by analyzing user interactions with the automation components;
resolve conflicts that require human intervention by connecting relevant users through a collaborative interface that supports real-time communication and decision-making;
track contributions and modifications made by each user to test scenarios, providing a detailed audit trail for accountability, version control, and collaborative decision-making;
a scanner engine component configured to:
scan a plurality of step definition code files and feature files within an automation suite to identify binding expressions, wherein the scanner engine component is designed to be tool-agnostic, script-agnostic, and language-agnostic, ensuring compatibility with diverse development environments and languages;
store the identified binding expressions in a first file and the corresponding matching statements from the feature files in a second file, wherein these files serve as temporary repositories that organize and categorize the identified automation components for further processing;
repeatedly scan and consolidate binding expressions and matching statements from additional files until the scanning process is complete, ensuring comprehensive scope of the automation suite;
a smart AI engine component configured to:
analyze contents of the first and second files to detect and resolve redundancies, discrepancies, duplications, and conflicts within the automation suite, utilizing advanced artificial intelligence techniques, including machine learning algorithms, that continuously learn and improve based on historical data and user feedback;
facilitate real-time consolidation and synchronization of automation components across multiple users, ensuring that all components within a shared workbench are consistent, up-to-date, and aligned with overall testing strategy;
automatically adjust frequency and granularity of real-time updates, suggestions, and conflict resolution activities based on complexity of a test scenario, user preferences, and the current state of the automation suite, thereby optimizing the system's responsiveness and effectiveness;
adapt to changes in software under test by continuously learning from user inputs, feedback, and changes in a software environment, ensuring that the automation components remain relevant, effective, and aligned with evolving requirements;
a multi-modal AI engine component configured to:
process user inputs in a form of free-form handwriting and voice, converting these inputs into text in real-time using advanced handwriting recognition and voice recognition technologies, wherein a conversion process is optimized to accurately handle variations in handwriting styles, speech patterns, accents, and dialects;
analyze the converted text using a natural language processing (NLP) engine to identify relevant automation components based on specific context of the user input, including module, feature, or priority level of the software being tested;
generate contextually appropriate suggestions for automation components, dynamically and continuously updating these suggestions via a smart bubble pane displayed on a smart scenario designer interface, wherein the smart bubble pane is responsive to the user's ongoing inputs and interactions;
a natural language processing (NLP) engine configured to:
analyze and interpret the converted text from handwriting and voice inputs, utilizing semantic analysis, context detection, and machine learning models to accurately identify relevant automation components and generate suggestions that are contextually aligned with user objectives;
continuously adapt and refine the NLP processing rules and algorithms based on historical data, user feedback, and evolving software requirements, ensuring that the system remains effective in interpreting and responding to user inputs over time;
a smart scenario designer interface configured to:
display the smart bubble pane that dynamically presents relevant automation components and suggestions based on the user's input and context, allowing the user to select and incorporate these components into the test scenario in real-time;
provide an interactive, user-friendly environment for scenario creation, allowing users to easily input, modify, and organize test scenarios using drag-and-drop functionality and other intuitive tools;
enable customization of an interface layout, tools, and workflows to suit individual user preferences, including adjusting the interface for different user roles, skill levels, and tasks, thereby enhancing productivity and user satisfaction;
support voice input customization, allowing the system to adapt to different accents, speech patterns, and languages, ensuring accuracy and inclusivity for a diverse range of users;
allow real-time simulation and preview of test scenarios, enabling users to visualize potential outcomes, identify issues, and make adjustments before finalizing and executing the scenarios, thereby reducing risk of defects and inefficiencies;
enable export of test scenarios into multiple formats, such as XML, JSON, or script files, ensuring compatibility with various automation frameworks, tools, and continuous integration/continuous deployment (CI/CD) pipelines;
a shared workbench engine component configured to:
store the consolidated and updated automation components in a centralized repository that is accessible to all users across the distributed environment, ensuring that these components are always current and relevant;
facilitate real-time collaboration among multiple users, ensuring that all team members have access to the most up-to-date automation components, supporting distributed teams working across different locations, time zones, and development environments;
integrate external data sources, including third-party APIs, databases, and cloud services, into the shared workbench to enhance the relevance, accuracy, and scope of the automation component suggestions provided to users;
enable version control for the automated components stored in the repository, allowing users to track changes over time, compare different versions, and revert to previous versions if necessary to maintain the integrity and reliability of the automation suite;
a generative AI component configured to:
generate optimized test scenarios based on the user's input, historical data, and the context of the software under test, wherein the generated scenarios are refined to maximize test scope, efficiency, and alignment with the overall testing strategy;
provide advanced recommendations for optimizing test scenarios, such as suggesting alternative automation components, refining test data inputs, or adjusting test execution parameters based on machine learning insights and patterns derived from past scenarios;
continuously update and refine the generated test scenarios based on ongoing feedback from a continuous integration/continuous deployment (CI/CD) process, ensuring that the scenarios remain relevant and effective as the software evolves;
a continuous deployment (CD) integration module configured to:
automatically apply validated and approved test scenarios to the production environment as part of the CI/CD pipeline, ensuring seamless integration of the automated tests into an overall software deployment process;
adapt the deployment process based on real-time feedback and changes in the software under test, ensuring that the automation suite remains aligned with the latest software updates and releases;
a multi-language support module configured to:
enable the smart scenario designer interface to support multiple languages, allowing global teams to author, manage, and collaborate on test scenarios in their preferred languages;
provide language-specific optimizations for handwriting and voice recognition, ensuring accuracy and usability across different linguistic contexts;
an audit trail module configured to:
provide a comprehensive audit trail that logs all changes made to test scenarios, including the identity of the user who made the changes, rationale for the modifications, and impact on the overall automation suite, ensuring transparency, accountability, and traceability throughout the automation process;
allow users to access and review the audit trail at any time, supporting compliance, quality assurance, and collaborative decision-making within the DevOps environment;
wherein the system is further configured to:
automatically update automation components and test scenarios based on continuous integration and deployment feedback, ensuring that the automation suite evolves in alignment with ongoing development processes; and
facilitate the real-time monitoring and analysis of test scenario execution, providing insights and metrics that enable users to continuously optimize their automation strategies and improve software quality over time.
